(19) United States
(12) Patent Application Publication
(10) Pub. No.: US 2026/0095870 A1
(43) Pub. Date: Apr. 2, 2026

(54) TRANSMISSION POWER IN WIRELESS COMMUNICATION SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 19/323,863

(22) Filed: Sep. 9, 2025

Related U.S. Application Data
(60) Provisional application No. 63/700,243, filed on Sep. 27, 2024.

(51) Int. Cl. H04W 52/14; H04W 52/36

(52) U.S. Cl. CPC H04W 52/146; H04W 52/367

(57) ABSTRACT

Apparatuses and methods for transmission power in wireless communication systems. A method includes receiving information for uplink (UL) transmissions and downlink (DL) receptions on a cell and determining, based on the information, a first UL duty cycle associated with a first UL transmission in a first subset of slots from a set of slots on the cell. The method further includes determining, based on the information, a second UL duty cycle associated with a second UL transmission in a second subset of slots from the set of slots on the cell, determining a first UL transmit power and a second UL transmit power based on the first and second UL duty cycles, respectively, and performing an UL transmission in a slot based on the first UL transmit power or the second UL transmit power.

### CROSS REFERENCE TO RELATED APPLICATIONS AND CLAIM OF PRIORITY

The present application claims priority under 35 U.S.C. § 119 (e) to U.S. Provisional Patent Application No. 63/700,243 filed on Sep. 27, 2024, which is hereby incorporated by reference in its entirety.

### TECHNICAL FIELD

The present disclosure relates generally to wireless communication systems and, more specifically, the present disclosure is related to apparatuses and methods for transmission power in a wireless communication system.

### BACKGROUND

6th generation (6G) is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

### SUMMARY

The present disclosure relates to transmission power in a wireless communication system.

In one embodiment, a method is provided. The method includes receiving information for uplink (UL) transmissions and downlink (DL) receptions on a cell and determining, based on the information, a first UL duty cycle associated with a first UL transmission in a first subset of slots from a set of slots on the cell. The method further includes determining, based on the information, a second UL duty cycle associated with a second UL transmission in a second subset of slots from the set of slots on the cell, determining a first UL transmit power and a second UL transmit power based on the first and second UL duty cycles, respectively, and performing an UL transmission in a slot based on the first UL transmit power or the second UL transmit power.

In another embodiment, a UE is provided. The UE includes a transceiver configured to receive information for UL transmissions and DL receptions on a cell and a processor operably coupled with the transceiver. The processor is configured to determine, based on the information, a first UL duty cycle associated with a first UL transmission in a first subset of slots from a set of slots on the cell, determine, based on the information, a second UL duty cycle associated with a second UL transmission in a second subset of slots from the set of slots on the cell, and determine a first UL transmit power and a second UL transmit power based on the first and second UL duty cycles, respectively. The transceiver is further configured to perform an UL transmission in a slot based on the first UL transmit power or the second UL transmit power.

In yet another embodiment, a base station (BS) is provided. The BS includes a transceiver configured to transmit information for UL transmissions and DL receptions on a cell and a processor operably coupled with the transceiver. The processor is configured to determine, based on the information, a first UL duty cycle associated with a first UL transmission in a first subset of slots from a set of slots on the cell, determine, based on the information, a second UL duty cycle associated with a second UL transmission in a second subset of slots from the set of slots on the cell, and determine a first UL transmit power and a second UL transmit power based on the first and second UL duty cycles, respectively. The transceiver is further configured to receive an UL transmission in a slot. The UL transmission is based on the first UL transmit power or the second UL transmit power.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a timeline of an example time division duplexing (TDD) configuration according to embodiments of the present disclosure;

FIG. 11 illustrates timelines of example full-duplex (FD) configurations according to embodiments of the present disclosure;

FIG. 12 illustrates a timeline of an example separate UL duty cycle determination according to embodiments of the present disclosure;

FIG. 13 illustrates flowchart of an example UE procedure for separate UL duty cycle determination according to embodiments of the present disclosure;

FIG. 14 illustrates a timeline of an example separate UL duty cycle determination according to embodiments of the present disclosure;

FIG. 15 illustrates a timeline of an example power control (PC) determination based on separate UL duty cycles according to embodiments of the present disclosure;

FIG. 16 illustrates flowchart of an example UE procedure for PC determination based on separate UL duty cycles according to embodiments of the present disclosure; and

FIG. 17 illustrates an example method performed by a UE in a wireless communication system according to embodiments of the present disclosure.

### DETAILED DESCRIPTION

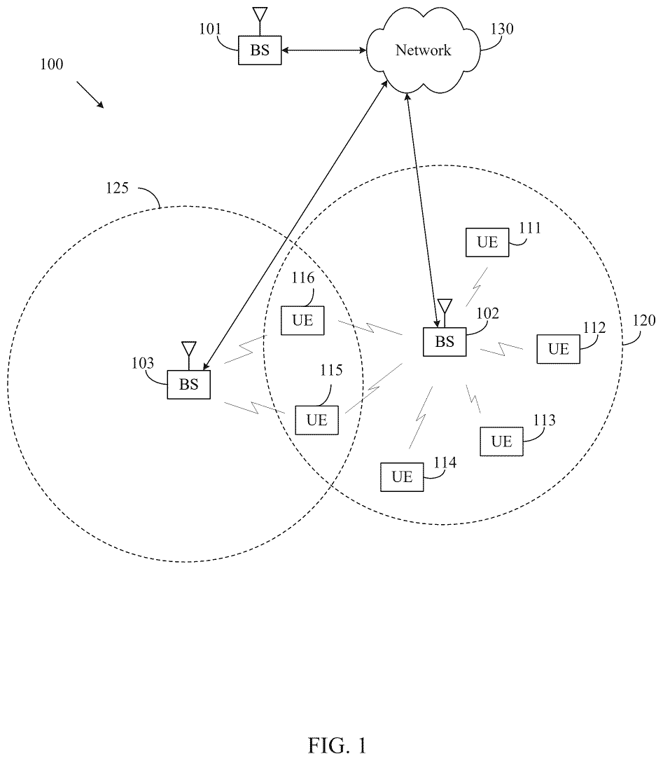

FIGS. 1-17 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G/LTE communication systems, and to enable various vertical applications, 5G/NR communication systems have been developed and are currently being deployed. The 5G/NR communication system can be implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support. 6th generation (6G) cellular communications is recently gathering increased momentum with all the worldwide technical activities on the various candidate technologies from industry and academia. The candidate enablers for the 6G communication system include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may also be applied to deployment of 6G communication systems, to deployment of 5G/NR communication systems, to deployment of 4G/LTE communication systems, or even for deployments which may use terahertz (THz) bands in later releases.

The following documents and standards descriptions are hereby incorporated by reference into the present disclosure as if fully set forth herein: 3GPP TS 38.211 v18.3.0, “NR; Physical channels and modulation” (REF 1); 3GPP TS 38.212 v18.3.0, “NR; Multiplexing and Channel coding” (REF 2); 3GPP TS 38.213 v18.3.0, “NR; Physical Layer Procedures for Control” (REF 3); 3GPP TS 38.214 v18.3.0, “NR; Physical Layer Procedures for Data” (REF 4); 3GPP TS 38.321 v18.2.0, “NR; Medium Access Control (MAC) protocol specification” (REF 5); 3GPP TS 38.331 v18.2.0, “NR; Radio Resource Control (RRC) Protocol Specification” (REF 6); 3GPP TS 38.101-1 v18.6.0, “NR; UE radio transmission and reception; Part 1: Range 1 Standalone (REF 7); 3GPP TS 38.101-2 v18.6.0, “NR; UE radio transmission and reception; Part 2: Range 2 Standalone (REF 8); 3GPP TS 38.101-3 v18.6.0, “NR; UE radio transmission and reception; Part 3: Range 1 and Range 2 Interworking operation with other radios” (REF 9); and 3GPP TS 38.133 v18.6.0, “NR; Requirements for support of radio resource management” (REF 10).

FIGS. 1-17 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 6G, 5G/new radio (NR), 4G/long term evolution (LTE) or long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station, a macrocell, a femtocell, a WiFi access point (AP), or other wirelessly enabled devices. Base stations may provide wireless access in accordance with one or more wireless communication protocols, e.g., 6G, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or a vending machine or a fixed wireless access node).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining transmission power in a wireless communication system. In certain embodiments, one or more of the BSs 101-103 include circuitry, programing, or a combination thereof to support determination of transmission power in a wireless communication system.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

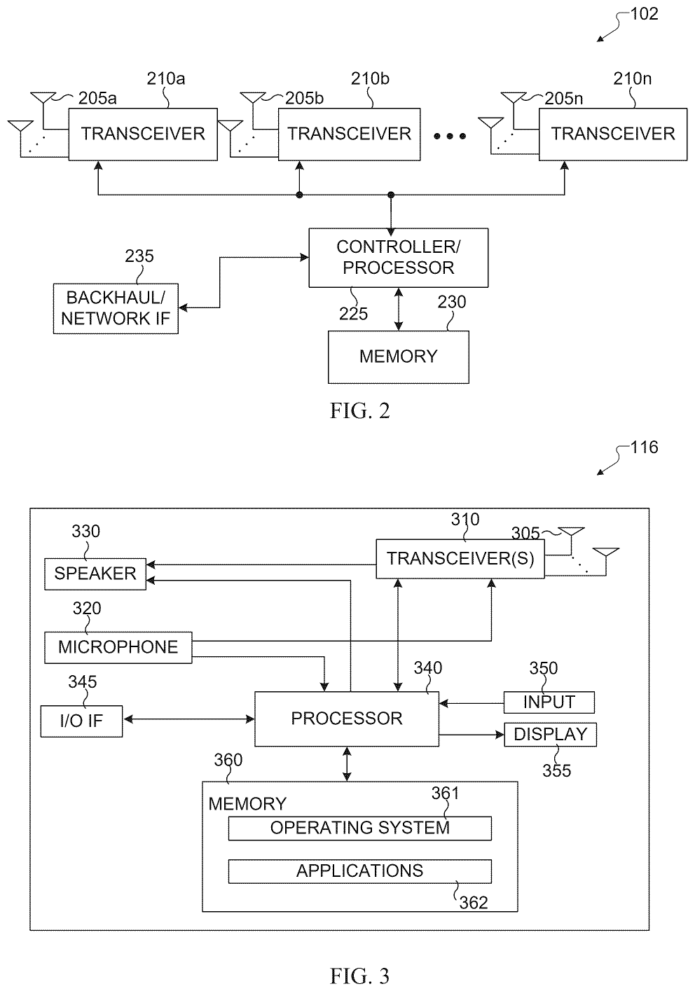

FIG. 2 illustrates an example TRP 102 according to embodiments of the present disclosure. For example, the TRP 200 any be a base station, such as gNB 101-103, or may be an NCR or smart repeater (SR), such as the relay node 104 in FIG. 1. The embodiment of the TRP 102 illustrated in FIG. 2 is for illustration only. However, TRPs come in a wide variety of configurations, and FIG. 2 does not limit the scope of the present disclosure to any particular implementation of a TRP.

As shown in FIG. 2, the TRP 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for transmission power in wireless communication systems. Any of a wide variety of other functions could be supported in the TRP 102 by the controller/processor 225.

The controller/processor 225 is also capable of executing programs and other processes resident in the memory 230, such as processes to support determination of transmission power in a wireless communication system. The controller/processor 225 can move data into or out of the memory 230 as required by an executing process.

The controller/processor 225 is also coupled to the backhaul or network interface 235. The backhaul or network interface 235 allows the TRP 102 to communicate with other devices or systems over a backhaul connection or over a network. The interface 235 could support communications over any suitable wired or wireless connection(s). For example, when the TRP 102 is implemented as part of a cellular communication system (such as one supporting 6G, 5G/NR, LTE, or LTE-A), the interface 235 could allow the TRP 102 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 102, various changes may be made to FIG. 2. For example, the TRP 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for determination of transmission power in wireless communication systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

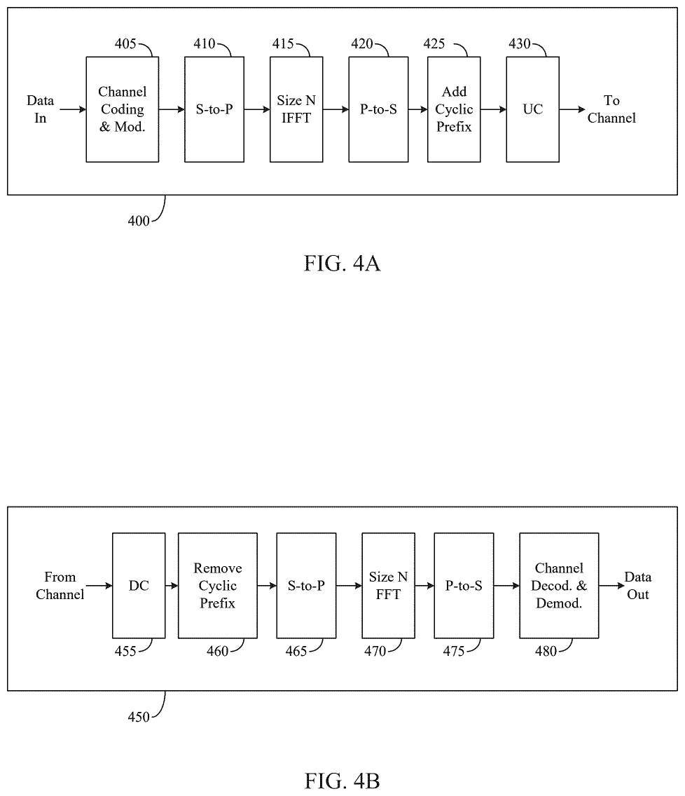

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for operation in a 6G or 5G/NR or 4G/LTE in a wireless communication system as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or the TRP 200 and may implement a receive path 450 for receiving in the downlink from gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

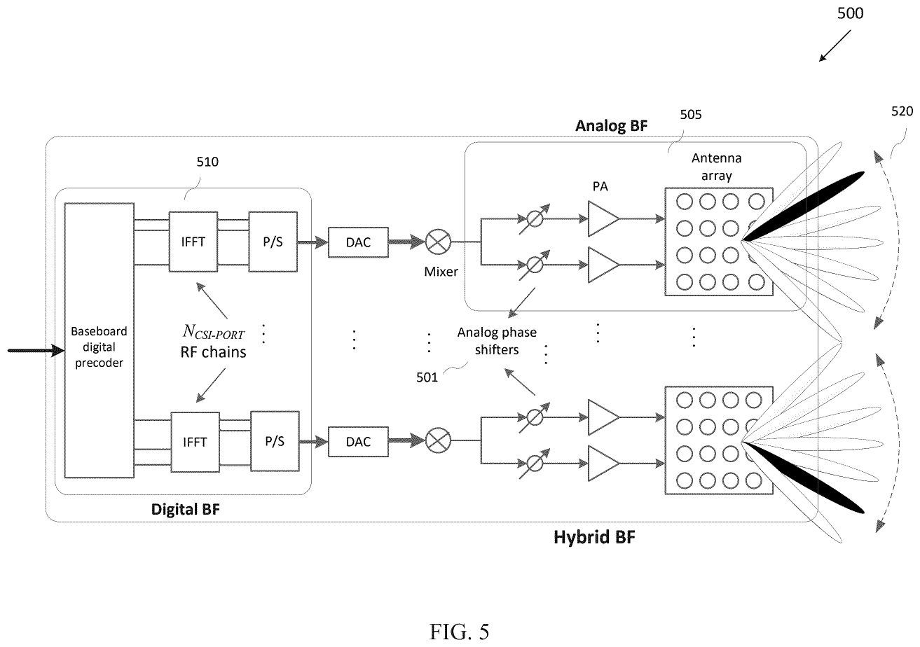

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

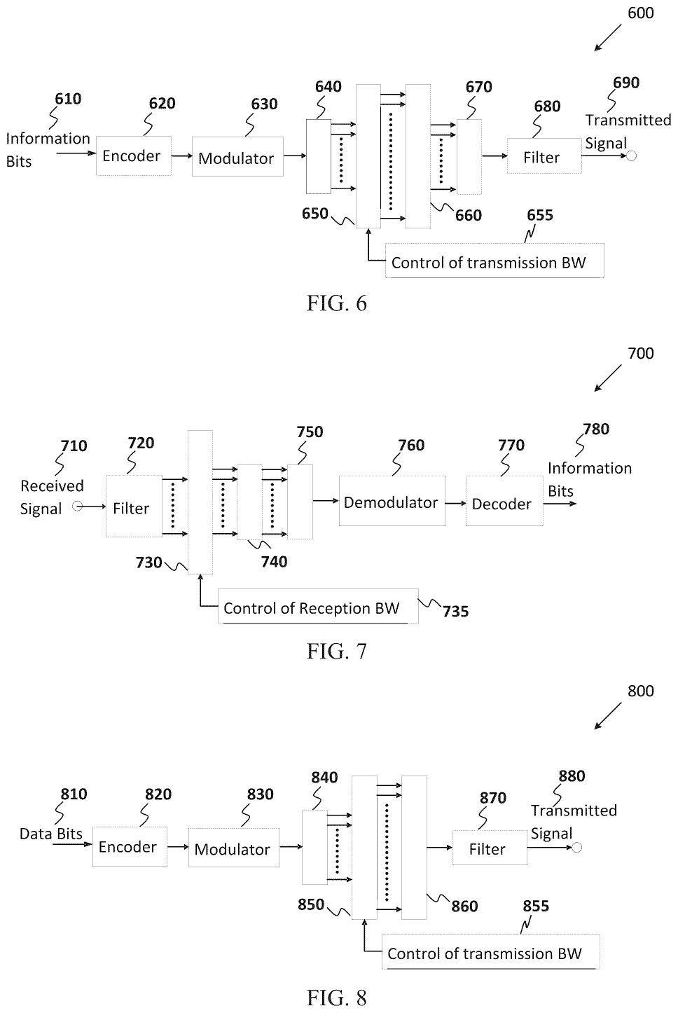

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder or a low-density-parity-check (LDPC) decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

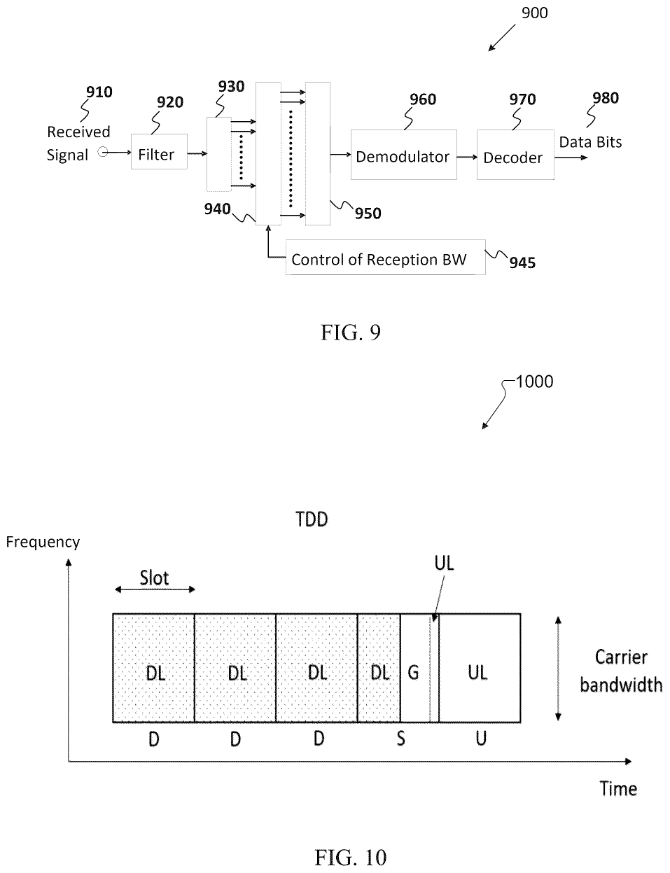

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder or a low-density-parity-check (LDPC) decoder, decodes the demodulated data to provide an estimate of the information data bits 980.

The present disclosure relates generally to wireless communication systems and, more specifically, to UE procedures for UE transmitter power and uplink transmit power control for operation in a wireless communication system.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI/configured scheduling RNTI (CS-RNTI)/modulation and coding scheme (MCS)-C-RNTI as described in REF2, are referred for brevity as a unicast DCI format. A DCI format scheduling PDSCH reception for multicast communication, such as a DCI format with CRC scrambled by group (G)-RNTI/G-CS-RNTI as described in REF2, are referred to as multicast DCI format. DCI formats providing various control information to at least a subset of UEs in a serving cell, such as DCI format 2_0 in REF2, are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA. A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTOIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m} The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

FIG. 10 illustrates a timeline 1000 of an example TDD configuration according to embodiments of the present disclosure. For example, timeline 1000 can be followed by any of the UEs 111-116 of FIG. 1 and the gNB 102 and/or network 130 in the wireless network 100 of FIG. 1. This example is for illustration only and other embodiments can be used without departing from the scope of the present disclosure.

With reference to FIG. 10, a DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL taking into account an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network (e.g., the network 130) to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross link interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. For example, transmissions and receptions on same symbols or slots may be separated in frequency by being placed in non-overlapping sub-bands. For example, transmission and receptions on a same symbol or slot using FD communications may occur with or without a sub-band such as when a subcarrier (SC), or a resource block (RB), or a resource block group (RBG) of a transmission is used for a simultaneous reception. An UL frequency sub-band, in time-domain resources that also include DL frequency sub-bands, may be located in the center of a carrier, or at the edge of the carrier, or at a selected frequency-domain position of the carrier. For example, the allocations of DL sub-bands and UL sub-bands may also partially or even fully overlap.

A gNB (e.g., the BS 102) may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. FD operation using an UL subband or a DL subband wherein at least from the UE perspective a DL reception in a DL subband and an UL transmission in an UL subband may occur in non-overlapping subbands may be referred to as SBFD. FD operation wherein at least from the gNB perspective a DL transmission or UL reception may occur in partially or fully overlapped frequency-domain resources may be referred to as single-frequency full-duplex (SFFD) or in-band full-duplex (IBFD). For example, SFFD or IBFD operation may or may not use an UL subband or a DL subband.

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols. For example, a slot/symbol configured as U by TDD-UL-DL-ConfigCommon in SIB1 or parameter ServingCellConfigCommon may be referred to as “non-SBFD” slot/symbol or as “normal” UL slot/symbol. For example, a slot/symbol configured as D and/or F by TDD-UL-DL-ConfigCommon in SIB1 or parameter ServingCellConfigCommon may be referred to as “SBFD” slot/symbol.

Instead of using a single carrier, different component carriers (CCs) can be used for receptions and transmissions by a UE. For example, receptions by a UE can occur on a first CC and transmissions by the UE occur on a second CC having a small, including zero, frequency separation from the first CC. For example, the component carriers may be provided to the UE using intra-band contiguous or non-contiguous or inter-band carrier aggregation. For example, when carrier-aggregation based full-duplex operation is used, an SBFD subband may correspond to a component carrier or a part of a component carrier or an SBFD subband may be allocated using parts of multiple component carriers. Instead of using a single carrier, it is also possible to use different bandwidth parts (BWPs) for receptions and transmissions by a UE. For example, receptions by a UE can occur on a first BWP and transmissions by the UE occur on a second BWP having a small, including zero, frequency separation from the first BWP. For example, when BWP based full-duplex operation is used, an SBFD subband may correspond to a BWP or a part of a BWP or an SBFD subband may be allocated using parts of multiple BWPs.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation or based on the use of BWPs.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support. For example, the SBFD-aware UE may operate according to the Rel-19 NR Duplex enhancements feature.

In the following, for brevity, a UE (e.g., the UE 116) operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode. In one example, a gNB may operate in full-duplex (or SBFD) mode on a carrier in band. In one example, a gNB may operate in full-duplex (or SBFD) mode across one or more carriers in a band. In one example, a gNB may operate in full-duplex (or SBFD) mode across one or more carriers in two or more bands.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present disclosure recognize that full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, for conciseness of description and illustration purposes, the term SBFD is used as a short form for a full-duplex operation in a wireless system. The terms ‘cross-division-duplex’ (XDD), ‘full duplex’ (FD), ‘subband-full-duplex’ (SBFD), or ‘single frequency full-duplex’ (SFFD), or ‘adaptive Duplex’ or ‘SBFD’ operation in a wireless communication system supporting ‘full duplex’ may correspond to one or a combination of ‘half-duplex’ (or non-simultaneous transmission and reception capability) and/or ‘full duplex’ (or simultaneous transmission and reception capability) by one or more wireless communication devices such as a UE or a gNB/BS/TRP in a wireless communication network. For example, a simultaneous or a (non-) simultaneous transmission and reception capability may be associated with a single carrier operation in a band, or with one or more bandwidth parts or bandwidth segments operation in one or multiple bands, or with a carrier aggregation or dual-connectivity operation in one or multiple bands.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

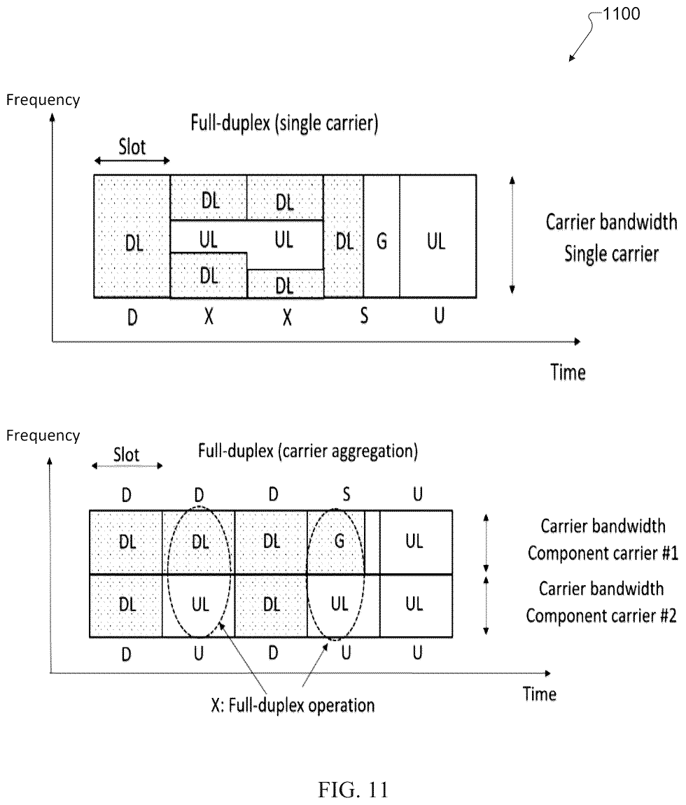

FIG. 11 illustrates timelines 1100 of example FD configurations according to embodiments of the present disclosure. For example, timelines 1100 can be followed by any of the UEs 111-116 and the gNB 102 and/or network 130 in the wireless network 100 of FIG. 1. This example is for illustration only and other embodiments can be used without departing from the scope of the present disclosure.

With reference to FIG. 11, for a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation.

Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrates diagrams, various changes may be made to the diagrams 1000-1100 of FIGS. 10-11. For example, while certain diagrams (such as diagrams 1000, 1100) describe a certain slot structure, various components combined, further subdivided, or omitted and additional components can be added according to particular needs.

In the following and throughout the disclosure, various embodiments of the disclosure may be also implemented in any type of UE including, for example, a 6G UE, or a UEs with the same, similar, or more capabilities compared to a Rel-21 6G or a 5G/NR UEs. Although various embodiments of the disclosure discuss 3GPP 6G 5G/NR wireless communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=20 for Rel-20, or xx=21 for Rel-21, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3 when using 5G/NR.

Throughout the disclosure, an SSB is used as a short form for a SS/PBCH block. The terms SSB and SS/PBCH block are interchangeably used in this disclosure.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config.

For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type ‘D’, ‘U’, or ‘F’ or a slot or a symbol type ‘SBFD’ or ‘non-SBFD’ or for an SBFD subband type such as ‘SBFD DL subband’, ‘SBFD UL subband’, or ‘SBFD Flexible subband’. In one example, the SBFD configuration and/or parameters associated with the SBFD configuration are same for TRPs. In one example, the SBFD configuration and/or parameters associated with the SBFD configuration can be TRP specific following the aforementioned configuration examples mentioned herein.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as ‘non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to TRPs in the cell. In one example, the SBFD configurations are separately provided for each TRP in the cell. In one example, a common SBFD configuration is provided for a cell, and an additional delta configuration is separately provided for each TRP in the cell, wherein the delta configuration can include additional frequency/time domain resources to be added to the common configuration and/or excluded frequency/time domain resources to be excluded from the common configuration. In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured TDRA table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

Using the Rel-19 NR Duplex feature, for example, the UE may be provided with a set of symbols or slots for an SBFD subband based on sbfd-config. For example, a DL or flexible symbol provided by parameter tdd-UL-DL-ConfigurationCommon can include an UL sub-band provided by ulSubbandlocationAndBandwidth, a first DL sub-band may be provided by firstdlSubbandlocationAndBandwidth and may additionally include a second DL sub-band provided by seconddlSubbandlocationAndBandwidth, for a SCS configuration u of any configured UL BWP or DL BWP, respectively, as provided by parameter scs-SpecificCarrierList. The downlink or flexible symbol can then be referred to as an SBFD symbol; or otherwise as a non-SBFD symbol. For example, SBFD symbols may be provided in consecutive order, starting from a first slot provided by parameter SBFD-StartingSlotIndex and from a first symbol in the first slot provided by SBFD-StartingSymbolInd, and end in a second slot provided by SBFD-EndingSlotindex and in a second symbol in the second slot provided by SBFD-EndingSymbolIndex. SBFD symbols may be provided in any of pattern1 and, if provided, pattern2 of tdd-UL-DL-ConfigurationCommon. A configuration period for SBFD symbols may correspond to P msec when only pattern1 is provided, or P+P₂ when pattern2 is additionally provided.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz” or “6G band 7-8 GHz”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REF7. For example, the term “FR1 4 GHz” may be used interchangeably with a term such as “FR1 band 4 GHz” or “6G band 4 GHz”.

In certain embodiments, 5G/NR or 4G/LTE radio access may be supported on a carrier or in a band of a frequency range corresponding to an FR1 operating band, or 5G/NR radio access may be supported on a carrier or in a band of an FR2 operating band such as defined in REF7 for 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-) select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT corresponds to one of 5G/NR radio access or 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access or may also support other wireless radio access.

For example, when operating in dual RAT mode based on principles such as described in REF11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

The UE (e.g., the UE 116) needs to conform to regulatory requirements such as maximum permissible exposure (MPE) requirements to limit the total RF exposure experienced by a user. RF exposure can fall in two categories. A first category is the specific absorption rate (SAR). SAR applies to frequencies below 6 GHz. SAR is measured in units of Watts/kg and reflects the amount of power absorbed by a certain volume of tissue. A second category is power density (PD) and applies to frequencies above 6 GHz. PD is measured in units of Watts/cm² and reflects the amount of power incident on the surface of tissue. Using Rel-15 NR, SAR is used as metric when taking into account the FR1 band below 6 GHz and PD is used as metric when taking into account the FR2-1 (mm Wave) bands.

For example, requirements from the FCC and the International Commission on Non-Ionizing Radiation Protection (ICNIRP) limit the MPE. Limits on SAR and PD are taken into account jointly. The individual SAR and PD values are normalized by the respective regulatory limits as seen in equation (E1):

$${\sum }_{i = 100 kHz}^{6 GHz} \frac{{SAR}_{i}}{{SAR}_{lim}} + {\sum }_{j = 6 GHz}^{300 GHz} \frac{{PD}_{j}}{{PD}_{lim}} \leq 1 \qquad ( E1 )$$

Here, SARᵢ refers to the time-averaged SAR in an RF band i and is determined according to equation (E2) where SARᵢ(τ) is the instantaneous SAR in band i. PDⱼ refers to the time-averaged PD in band j and is given by equation (E3) where PDⱼ(τ) is the instantaneous PD in band j. T_{SAR} and T_{PD} are the time windows for averaging, respectively. SARₗᵢₘ is a total regulatory limit for SAR. PDₗᵢₘ is a total regulatory limit for PD. Note that determination of the SAR and the PD is to include transmissions across frequencies and radio technologies of a UE, e.g., including Wi-Fi, or Bluetooth, or wireless transmission other than cellular radio when present.

$${SAR}_{i} = \frac{1}{{T}_{SAR}} {\int }_{t - {T}_{SAR}}^{t} {SAR}_{i} ( τ ) d τ \qquad ( E2 )$$

$${PD}_{j} = \frac{1}{{T}_{PD}} {\int }_{t - {T}_{PD}}^{t} {PD}_{i} ( τ ) d τ \qquad ( E3 )$$

The PD is typically measured over 4 cm² area and is limited to 1 mW/cm². A time averaging of 4 seconds can be used for frequencies from 24 GHz to 42 GHz. The SAR may be limited to 1.6 W/kg measured over 1 g of tissue. A time averaging window of 360 seconds can be used. Certain aspects of the measurement or evaluation procedure may vary across regulatory domains or countries.

The time averaging is an important UE implementation aspect when the UE monitors the RF exposure limits such as MPE. For example, the UE can monitor its wireless transmissions and determines or estimates the amount of generated RF exposure using a sliding time window for averaging. The UE can then determine an amount of allowable RF exposure such as MPE for a next period of time such as the next several hundred msec or the next 1 sec. The UE then uses an estimated, e.g., an allowable RF exposure limit to determine a maximum output power while adhering to the parameterization and closed-loop power-control commands from the gNB (e.g., the BS 102) according to the UL transmit power control procedure. For example, when an estimated or an allowable RF exposure limit is determined by the UE to be in excess of RF exposure limits, the UE may then use power class fallback or P-MPR based mitigation to reduce the RF exposure below acceptable levels using Rel-15 NR specifications as further described herein.

Using Rel-15 NR, a UE maximum transmit power or maximum output power can depend on a number of factors such as the UE maximum output power or UE Power Class (PC) and/or a power reduction that a UE is allowed under certain conditions.

A UE Power Class such as defined in REF7 defines the maximum output power for any transmission bandwidth within the channel bandwidth of an NR carrier for FR1 or defines the maximum output power radiated by the UE for any transmission bandwidth within the channel bandwidth for FR2. For example, a UE power class may be specified or tested based on conducted or cabled measurements in FR1, or based on over-the-air (OTA) measurements in FR2. For example, the period of measurement may be at least one subframe (1 msec). For example, in the case of FR3, a UE Power Class may be defined according to FR1 for operating frequencies in the range of 6-8 GHz. For example, in the case of FR3, a UE Power Class may be defined according to FR2 for operating frequencies in the range of 13 GHz.

Using Rel-15 NR, several UE Power Classes are defined for FR1, such as power class 1 (PC1), power class 1.5 (PC1.5), power class 2 (PC2), power class 3 (PC3) or power class 4 (PC4). For example, UEs operating within FR1 typically support a maximum output power according to power class 3 (PC3), e.g., 23 dBm, or power class 2 (PC2), e.g., 26 dBm. PC3 may be regarded the default power class for FR1. Power classes 2 or 1.5 may only be applicable to specific operating bands such as applicable in NR bands n78 or n41 but not applicable in NR band n7. PC3 may be applicable for FR1 operating bands.

Using Rel-15 NR and for FR2, a maximum equivalent isotropic radiated power (EIRP) limit may be used to satisfy regulatory requirements, i.e. ensuring that the UE does not transmit at such high power that health issues would be caused or excessive interference would be caused. A maximum EIRP takes into account maximum antenna gain which can be generated by the FR2 UE. ‘Mobile’ UEs are specified to have a maximum EIRP of 43 dBm, while ‘transportable’ UEs are specified to have a maximum EIRP of 55 dBm according to REF7. A minimum peak EIRP may be used to ensure that a UE can generate at least a minimum output power in one specific direction. A total radiated power (TRP) for a UE can define an upper limit on the total power radiated in directions. For example, UEs operating within FR2 may support a power class 1, 2, 3 or 4 wherein a power class can correspond to an assumed use case or application which is associated with each UE power class. For example, power class 1 (PC1), e.g., with maximum total radiated power (TRP) of 35 dBm and maximum peak EIRP of 55 dBm is intended for fixed wireless access (FWA) and has the highest transmit power capability. For example, power class 2 (PC2) for vehicular applications, power class 3 (PC3) for handheld UEs and power class 4 (PC4) for high-power non-handheld UEs can have equal maximum TRP of 23 dBm and maximum peak EIRP requirements of 43 dBm but different minimum peak EIRP requirements.

Using Rel-15 NR, a UE may be allowed a power reduction under certain conditions. For example, a first type of power reduction can be allowed for the UE to accommodate higher order modulations and/or transmit bandwidth configurations and may be referred to as maximum power reduction (MPR). A second type of maximum power reduction may be allowed for the UE to meet stringent spectral emission requirements and may be referred to as Additional Maximum Power Reduction (A-MPR). A third type of power reduction can be allowed for the UE to accommodate Power Management Maximum Power Reduction (P-MPR) to comply with MPE requirements. More than one power reduction associated with different types may be applied by the UE for an UL transmission.

An MPR such as defined in REF7 allows the UE to reduce the maximum output power due to higher order modulations and transmit bandwidth configurations. MPR can specify a power back-off for certain NR waveforms such as 16QAM or 64QAM and/or for location of the RBs in the operation band. The UE may not be able to generate and transmit a waveform for the maximum power according to the UE power class while also adhering to adjacent channel leakage ratio (ACLR), in-band emission (IBE), error vector magnitude (EVM) and spectral emission mask (SEM) constraints. For example, MPR values provided in REF7 are chosen such that a UE can still generate a waveform at a reasonable implementation complexity while respecting applicable ACLR, IBE, EVM and/or SEM requirements. For example, an MPR value may be used by the UE to calculate a lower bound on its P_{CMAX,f,c} value. The MPR value numbers may represent the maximum amount of power back-off which is allowed for the UE. The UE may or may not use such a maximum allowance when determining its UL transmit power for an UL transmission for as long as the UE can still meet applicable ACLR, IBE, EVM and/or SEM requirements.

An A-MPR is an additional maximum power reduction allowed for the maximum output power as specified in REF7. For example, the total reduction to the UE maximum output power can be max (MPR, A-MPR). For example, an MPR and/or A-MPR can be based on an outer, inner or edge RB allocation, or a modulation and waveform type, or an associated network signaling label with further details provided in REF7.

A P-MPR is power management maximum power reduction for serving cell. For example, P-MPR may be used by the UE for ensuring compliance with applicable electromagnetic energy absorption requirements such as MPE and/or addressing unwanted emissions or self-de-sense requirements in case of simultaneous transmissions on multiple radio access technologies (RAT(s)) or when proximity detection is used to address such requirements that would require a lower maximum output power. For example, based on the available maximum output transmit power and/or P-MPR of the UE, a gNB may adjust the scheduling decisions. For example, P-MPR may impact the maximum UL performance for the selected UL transmission path.

Using Rel-15 NR, for example, two approaches are for the UE implementation to autonomously reduce its maximum transmit power in order to adjust the UL transmissions according to RF exposure limits such as MPE. One approach is power class fallback when the UE supports a maximum transmit power higher than the default class. Another approach is to use the P-MPR allowance.

For example, using power class fallback, a PC2 UE can indicate to the gNB a maximum UL duty cycle up to which it is able to sustain the output power according to PC2 for its UL transmissions. For FR1, the maximum duty cycle is indicated by the parameter maxUplinkDutyCycle-PC2-FR1 in a UE capability message. When this parameter is not reported by a PC2-capable UE, it is expected to correspond to a default value, e.g., 50%. When UL scheduling occurs using dynamic and/or configured grants and the maximum duty cycle is exceeded, then the UE may operate as a PC3 UE. Similar instances apply to a PC1.5 capable UE. Power class fallback procedures to reduce a UE maximum output power may be used according to conditions such as further specified in REF7. Similarly, P-MPR based behavior may be used by the UE in conjunction with a maximum UL duty cycle to reduce a UE maximum output power as defined in REF7.

With reference to detailed NR UL transmit power control procedures according to Rel-15 NR, a UE determines an UL transmission power for PUSCH, PUCCH, SRS, and PRACH transmissions.

Using Rel-15 NR, the NR UL transmit power control is based on a combination of open-loop power control (OLPC) and closed-loop power control (CLPC) components. OLPC includes support for fractional pathloss compensation where the UE estimates a pathloss to a serving gNB, based on measurements for DL signals/channels from the serving gNB, and accordingly adjusts a transmission power. CLPC is based on transmit power control (TPC) commands provided by the gNB where, for example, the gNB may determine values for the TPC commands to the UE based on measurements of the received power for transmissions from the UE. The NR UL power control procedure also supports beam-based power control.

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c} (i, j, q_{d}, l) in dBm in PUSCH transmission occasion i as,

$${P}_{PUSCH , b , f , c} ( i , j , {q}_{d} , l ) = min \{ \begin{matrix}{P}_{CMAX , f , c} ( i ) , \\ {P}_{0 \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

P_{CMAX}(.) is the configured maximum UE output power per carrier. P₀(.) corresponds to a normalized target received power level that may be indicated by a serving gNB using one or multiple signaled higher layer parameters. PL(.) corresponds to a pathloss estimate by the UE, for example based on an SSB or a NZP CSI-RS. α(.) is a parameter for fractional pathloss compensation that is indicated by the serving gNB. M_{RB}(.) corresponds to the number of RBs for the PUSCH transmission when adjusting a normalized (per RB and 15 kHz SCS) target receive power. Δ_{TF}(.) may be associated with a modulation scheme and channel-coding rate used for the data information provided by the PUSCH transmission and can be viewed as modeling link capacity such as 80% of Shannon capacity. This term may not be included when determining a PUSCH transmit power and can be applicable only for single-layer UL transmissions. f(.) corresponds to a power adjustment state due to the CLPC component.

The configured maximum output power P_{CMAX,f,c} accounts for the UE power class, a maximum power reduction such as MPR, A-MPR, and/or P-MPR, and is set within the following bounds as described in REF7:

$${P}_{CMAX \_ L , f , c} \leq {P}_{CMAX , f , c} \leq {P}_{CMAX \_ H , f , c}$$

$$with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \}$$

$$and$$

$${P}_{CMAX \_ H , f , c} = MIN \{ {P}_{EMAX , c} , {P}_{PowerClass} - Δ {P}_{PowerClass} .$$

Here, P_{EMAX,c} is provided by higher layer provided parameter p-Max or by the field additionalPmax of the higher layer parameter NR-NS-PmaxList, as described in REF6. P_{PowerClass} is the maximum UE power of the applicable UE power class specified in REF7 without taking into account the tolerances specified in REF7. The parameter p-Max (range from −30 . . . 33) is used to limit the UE's transmission power on a carrier frequency and may also be used for the UE to calculate compensation factors during cell (re-)selection in RRC_IDLE and/or RRC_INACTIVE states. p-Max is the maximum transmit power allowed in a serving cell with value in dBm.

In addition to limiting a UE transmit power on a serving cell, a total UE transmit power over serving cells for the UE may also be limited. Such a limitation of the UE transmit power over multiple UL carriers may also apply in case of LTE/NR dual connectivity. For example, a maximum transmit power that the UE may use on a serving cell may then be additionally limited by parameters p-NR-FR1 configured for the cell group and p-(E-FR1 configured total power for serving cells operating on FR1. If absent, the UE applies the maximum power according to REF7 in case of an FR1 cell or an FR2 cell. Further details are described in REF7.

The sum P₀(.)+α(.) PL(.) is associated with OLPC and, for α(.)<1, it includes fractional pathloss compensation. For full pathloss compensation (α(.)=1), OLPC adjusts the PUSCH transmit power such that the received power aligns with the target received power P₀(.). For example, P₀(.) may be selected and indicated by the gNB to the UE depending on the target data rate and/or the noise and interference level experienced at the gNB receiver for the UE. For fractional pathloss compensation (α(.)<1), pathloss is not fully compensated while interference to neighbor cells is reduced. The gNB received power for transmissions from a UE may, on average, vary depending on the UE location within the serving cell. For example, for partial pathloss compensation, PUSCH transmissions from UEs experiencing larger pathloss, due to being at larger distances from the gNB, may be received by the gNB with lower power that PUSCH transmissions from UEs experiencing smaller pathloss. The gNB may compensate by adjusting the UL data rate of UEs accordingly and operate UEs located closer to the gNB with larger data rates than UEs located further from the gNB. In consequence, there may be larger variations in the service quality and reduced data rate availability for UEs further from the gNB (closer to the cell border) when using fractional pathloss compensation.

NR UL transmit power control procedures support beam-based power control. For example, a UE can be configured multiple DL reference signals for pathloss measurements, multiple OLPC parameter sets, and multiple CLPC processes.

In the case of beamforming, a pathloss estimate PL(.) that a UE uses to determine a transmit power should reflect the path loss, including the beamforming gains, of the paired UL beam that the UE uses to transmit a PUSCH. When DL/UL beam correspondence is assumed, the UE can estimate the pathloss based on measurements for a DL reference signal that is transmitted by the gNB over the corresponding paired DL beam. As the UL beam used for UL/DL beam pair may change across PUSCH transmissions, the UE may need to maintain multiple pathloss estimates corresponding to different candidate UL/DL beam pairs. The gNB can configure the UE with a set, such as up to 4, of DL reference signals for pathloss measurements, such as SSBs and/or NZP CSI-RSs. The gNB can also configure a mapping among SRS resource indicator (SRI) values and pathloss DL reference signals. A DCI format scheduling a PUSCH transmission can include a SRI field indicating one of the SRI values and the UE uses a pathloss estimate obtained from the DL RS associated with the indicated SRI value to determine a pathloss value to apply for the determination of the transmit power for the PUSCH transmission.

A UE can be configured multiple, such as up to 30, OLPC parameter sets {P₀(.), α(.)}, each corresponding to a pair of values for a normalized target receive power level and a fractional pathloss compensation coefficient. A UE may use parameter pair {P₀(1), α(1)} for PUSCH transmissions associated with configured grants while remaining parameter pairs are associated with PUSCH transmissions scheduled by DCI formats. The gNB may associate each value of the SRI field in a DCI format with one of the indicated OLPC parameter set pairs. For example, the gNB may select and indicate an OLPC parameter set using separate values for normalized target receive power level and fractional pathloss compensation coefficient, respectively, for each UL beam that can be used by the UE to transmit a PUSCH. For a PUSCH transmission before the UE receives dedicated configuration for OLPC parameters, such as for a Msg3 PUSCH transmission or for a PUSCH transmission scheduled by a DCI format with CRC scrambled by a temporary C-RNTI (TC-RNTI), fractional power control is not used, e.g., α(.)=1, and P₀(.) may be determined by the UE based on received information in the configuration of the random-access procedure.

With respect to multiple OLPC parameter sets, NR supports for a UE (e.g., the UE 116) to be configured with up to three values for the normalized target receive power P₀(.) resulting to up to three respective values for a PUSCH transmit power. A DCI format scheduling the PUSCH transmission can indicate one of the P₀(.) values for the UE to use in determining a power for the PUSCH transmission. For example, a DCI format 0_1 or a DCI format 0_2 may be configured to include a OLPC parameter set indication field and its associated index values are indicated by higher layer signaling such parameter P0-PUSCH-Set-r16 as described in REF2 and REF6. The OLPC parameter set indication field has length of 1 bit when the DCI format scheduling the PUSCH transmission also includes the SRI field and has length of 1 bit or 2 bits when the SRI field is not present. It is noted that the OLPC parameter set indication field indicates only the normalized target receive power setting P₀(.) and does not indicate the fractional pathloss coefficient α(.).

A UE can be configured with two SRS resource sets. Values of two SRS resource set indicator fields in a DCI format scheduling a PUSCH transmission can indicate a first and a second normalized target receive power P₀(.) from a first and a second OLPC parameter set p0-PUSCH-Alpha and p0-PUSCH-Alpha2, respectively, that is provided by higher layers. Determination of the target receive power and fractional pathloss compensation coefficient by the UE is per SRI field as in the case of a single SRI field in the DCI format.

Furthermore, the UE can be configured with multiple, such as 2, independent CLPC processes. Similar to having multiple pathloss DL reference signals and multiple OLPC parameter sets, the selection of the associated CLPC process by the UE can be configured by higher layers for the SRI value indicated by the DCI format.

The corresponding UL transmit power procedures for the cases of other UL channels or signals such as PUCCH, SRS or PRACH are further described in REF3.

When implementing UE procedures for UE transmitter power and UL transmit power control for operation in a wireless communication system, several issues related to limitations and drawbacks of existing technology need to be overcome in order to increase the UE communications range or to improve system operation according to channel conditions.

In one example, a wireless communication system supporting full-duplex operation is considered.

It needs to be taken into account that for receptions by a gNB using one or more TRPs on a cell in a full-duplex system, a different number of transmitter/receiver antennas, a different effective transmitter antenna aperture area, and/or different transmitter antenna directivity settings may be available for receptions in an UL slot or symbol, i.e., non-SBFD slot or symbol, when compared to receptions in a SBFD slot or symbol. An SBFD antenna configuration at the gNB may not be known to a UE. Similar instances may apply to gNB or TRP transmissions in a normal DL slot or symbol when compared to gNB or TRP transmissions in the DL subband of a SBFD slot. For example, the normalized target receive power settings in support of the UE uplink transmit power control for receptions by a gNB using one or more TRPs on a cell in a SBFD slot or symbol with full-duplex operation may be constrained to prevent TRP-side receiver automatic gain control (AGC) blocking and to enable effective implementation of serial interference cancellation (SIC) during TRP receptions in the UL subband of the SBFD slot or symbol when compared to the settings of TRP receptions in the normal UL slot. Therefore, the UE transmission power budget and, correspondingly, the received signal strength available for the gNB receiver, may not be same for a signal/channel being transmitted by the UE on a non-SBFD slot/symbol when compared to transmission by the UE of a same signal/channel on an SBFD slot/symbol. Similar observations hold when full-duplex transmission and reception by a gNB on a cell based on multiple antenna panels from one or more TRPs is implemented. For example, QCL and transmit timing may vary between different panels of a TRP or among different TRPs. The transmissions or receptions on a cell from/by a TRP may be subjected to different link gains depending on the antenna panel used in a transmission or reception instance. Transmissions to or receptions from a same UE using different TRPs may be subjected to different link gains depending on the TRP for a transmission or reception instance. Similar observations hold for transmissions or receptions using different SBFD subbands where different link conditions may result with respect to a same UE scheduled from the gNB (e.g., the BS 102) or across TRPs. For example, the available UL transmit power budget at a TRP for receptions on a cell may be more restricted in an SBFD UL subband of an SBFD slot when compared to receptions in a normal UL slot of the TRP.

Furthermore, interference levels experienced by the gNB receiver may differ between receptions in a normal UL slot or symbol and receptions in a SBFD slot or symbol. For example, in a synchronized TDD deployment with aligned TDD UL-DL frame configurations between gNBs, the gNB receiver during receptions in a normal UL slot may be interfered by co-channel transmissions from UEs in neighboring cells. The gNB receiver during receptions in an SBFD slot or symbol may also be subjected to gNB-to-gNB inter-subband co-channel and/or gNB-to-gNB adjacent channel cross-link interference (CLI) stemming from DL-to-UL interference during receptions by the gNB in the SBFD UL subband of an SBFD slot or symbol. Therefore, the resulting interference power levels and their variation experienced by the gNB receiver may not be same for reception of a signal/channel on non-SBFD slot/symbol when compared to reception of the signal/channel on an SBFD slot/symbol. Similar observations hold for transmissions from the gNB or receptions by the UE using different SBFD DL subbands. In presence of intra-cell or inter-cell TRP operation, larger variations may be expected due to non-co-location of the TRPs.

Therefore, different received SINR conditions, or different QCL assumptions, in non-SBFD slots/symbols and in SBFD slots/symbols, respectively, or in different SBFD subbands when operating in the full-duplex serving cell can be expected.

A first issue relates to existing UE power class fallback or P-MPR based mitigation procedures and the UL duty cycle according to the existing NR specifications, for example for ensuring compliance with the applicable electromagnetic energy absorption requirements based on MPE requirements or unwanted emissions or self-de-sense requirements.

Using existing technology, an FR1 UE can support a different power class such as PC2 or PC1.5 than the default UE Power Class PC3. The supported UE Power Class may allow a higher maximum output power than the default power class. The higher maximum output power can only be employed by the UE if the number of UL symbols for UL transmissions in a period do not exceed a certain supported (or default) UL duty cycle.

With reference to detailed existing NR procedures, if the field of UE capability maxUplinkDutyCycle-PC2-FR1 is absent and the field of UE capability maxUplinkDutyCycle-PC1dot5-MPE-FR1 is absent and the percentage of UL symbols transmitted in a certain evaluation period is larger than 50% wherein the evaluation period is no less than one radio frame; or if the field of UE capability maxUplinkDutyCycle-PC2-FR1 is not absent and the percentage of UL symbols transmitted in a certain evaluation period is larger than max UplinkDutyCycle-PC2-FR1; or if the field of UE capability maxUplinkDutyCycle-PC1dot5-MPE-FR1 is not absent and half the percentage of UL symbols transmitted in a certain evaluation period is larger than maxUplinkDutyCycle-PC1dot5-MPE-FR1, or if the IE p-Max is provided and set to the maximum output power of the default power class or lower; the UE may apply requirements for the default power class to the supported power class and set the configured transmitted power as further specified in REF7. If the UE does not support a power class with higher maximum output power than PC2; or if the field of UE capability maxUplinkDutyCycle-PC2-FR1 is absent and the field of UE capability maxUplinkDutyCycle-PC1dot5-MPE-FR1 is absent and the percentage of UL symbols transmitted in a certain evaluation period is larger than 25%; or if the field of UE capability maxUplinkDutyCycle-PC2-FR1 is not absent and the percentage of UL symbols transmitted in a certain evaluation period is larger than 0.5*maxUplinkDutyCycle-PC2-FR1; or if the field of UE capability maxUplinkDutyCycle-PC1dot5-MPE-FR1 is not absent and the percentage of UL symbols transmitted in a certain evaluation period is larger than maxUplinkDutyCycle-PC1dot5-MPE-FR1; or if the IE p-Max is provided and set to the maximum output power of the power class 2 or lower; the UE may apply requirements for power class 2 to the supported power class and set the configured transmitted power as further specified in REF7.

It needs to be taken into account that UL coverage in a full-duplex wireless communication system should be improved for a cell-edge UE operating at or close to the UE maximum output power. For example, the UL coverage of a cell-edge UE can then be improved by allocating a larger number of UL transmission opportunities in time domain. For example, the UE at or close to cell edge may be scheduled in the normal UL slot of a period and the SBFD UL subband in SBFD slots/symbols during the period. For example, UL transmissions using only the normal UL slot in a TDD UL-DL frame configuration of type ‘DDDSU’ as shown in FIG. 11 would result in an UL duty cycle of 20% over the period. UL transmissions from this same UE which can additionally use the SBFD UL subband in SBFD slots labeled as ‘X’ or ‘S in FIG. 11 would increase the UL duty cycle to 80%. For example, an even higher UL duty cycle of up to 95% may occur when the first slot labelled as ‘D’ in FIG. 11 can also be used for UL transmissions in the SBFD UL subband by the UE in DL slots where no SSB instance occurs. The resulting UL signal-to-noise-and-interference ratio (SINR) then increases as the UL duty cycle increases. The achievable UL coverage for the UE is increased.

Therefore, it can often be expected that an FR1, FR2 or FR3 UE which should benefit from the improved UL coverage provided by the SBFD feature may be configured or indicated to use most or all of the SBFD slots/symbols on the serving cell for prolonged periods of time such as when the UE is operating at cell edge or under unfavorable SINR conditions.

A first consequence is that the UE which is configured or indicated for UL transmissions in the SBFD UL subband in the full-duplex system may then often exceed its supported or a default UL duty cycle associated with the UE power class or the P-MPR based mitigation behavior.

For example, a supported or a default UL duty cycle for a given UE power class may be expressed as the percentage X of UL symbols in a certain evaluation period. For example, X=50% for FR1 PC2 or X=25% for FR1 UE PC1.5. When the UE is configured or indicated with an SBFD UL subband in a number of slots/symbols in the serving cell with full-duplex support, the UE would then autonomously reduce its maximum output power, e.g., based on the UE power class fallback or the P-MPR based mitigation procedures in existing NR specifications. For example, a UE supporting FR1 PC2, or 26 dBm, in the full-duplex cell may decide to use power-class fallback and then reduce to use a UE maximum output power according to FR1 PC3, or 23 dBm. In another example, the UE may apply P-MPR based mitigation of several dB and accordingly reduce the UE maximum output power. For example, a UE may determine to use power class fallback or apply the P-MPR based mitigation indiscriminately with respect to the slot/symbol type, e.g., for non-SBFD and SBFD slots/symbols. The UE would then use power class fallback or P-MPR based mitigation for any UL transmission in the non-SBFD (or normal UL) slot/symbols and in the UL subband of SBFD slots/symbols. Such resulting UE behavior would then result in a reduced UL coverage for the UE in the full-duplex cell.

A second consequence is that the gNB may not become instantly aware of when and why and under which conditions such UE a power class fallback or P-MPR based mitigation behavior occurs or is applied by the UE in the full-duplex system.

For example, the gNB may attempt to count or to track a number or scheduled or configured UL symbols for the UE to estimate an UL duty cycle for a UE. But RF exposure such as MPE is autonomously estimated by the UE and may depend on other factors such as other concurrently active radio transmitters in the UE implementation, an orientation of the device, or an evaluation period over which MPE is assessed by the UE, which are unknown to the gNB. Furthermore, when the UE does not transmit using high output power or hasn't reached the maximum output power according to its power class, the UE may not apply power class fallback even if the maximum duty cycle is exceeded. Much autonomy is given to UE implementation, which reduced the ability of the gNB to accurately estimate an available UL transmit power from the UE for a particular UL scheduling or UL transmission instance.

For example, using P-MPR based mitigation, the UE can reduce its maximum output power to avoid exceeding an RF exposure limit such as MPE in a period of time. The UE may use P-MPR based mitigation in conjunction with a certain UL duty cycle, e.g., based on an observed or an estimated UL scheduling activity. Using existing Rel-18 NR specifications when operating in FR2, a P-MPR indication can be provided by the UE to the gNB. For example, using power headroom reporting (PHR) in a MAC CE, a UE can report its instantaneous transmit power to transmit a PUSCH. The PHR can include a power headroom value of 6 bits, a P_{CMAX,f,c} value of 6 bits, and a P-MPR value of 2 bits. The power headroom value reflects an amount of additional transmit power a UE can support when compared to the current PUSCH transmit power level. P_{CMAX,f,c} reflects the corresponding maximum power a UE could support. The P-MPR value indicates a range within which a P-MPR was autonomously applied by the UE to the current transmission. However, the PHR can only provide information reactively, e.g., after the fact. Future UE behavior, including a future adjustment of the P-MPR based mitigation behavior by the UE cannot be inferred by the gNB.

Therefore, existing technology is insufficient to control or adjust the UE transmitter power and perform the UL transmit power control when operating in FD systems.

Accordingly, embodiments of the present disclosure recognize that there is a need for separate control and/or adjustment of the UE transmitter power or UE maximum output power for non-SBFD and SBFD slots/symbols, respectively, or for different SBFD subbands while ensuring compliance with applicable electromagnetic energy absorption requirements such as MPE and/or unwanted emissions or self-de-sense requirements, and/or thermal or heat dissipation management.

Similar considerations can be extended to a wireless communication system without full-duplex operation.

In one example, a wireless communication system supporting frequency-domain spectrum shaping (FDSS) is considered. For example, an UL transmission from a UE using FDSS in a slot may use a UE maximum output power such as according to PC2 or PC 1.5. A reason is that a higher resulting linearity of the spectrally shaped waveform according to FDSS can allow the use of a higher UE maximum output power when compared to a waveform without spectrum shaping while meeting applicable transmitter requirements such as spectral emissions or error-vector-magnitude (EVM) requirements. For example, an UL transmission of a QPSK or 16QAM waveform without spectrum shaping may use PC3 but with spectrum shaping may use PC2 or PC1.5 for a same UL power amplifier in the UE UL transmit path. Accordingly, UL transmissions from the UE may be subject to a maximum supported UL duty cycle for MPE or for thermal management similar to a case such as SBFD operation. An adjustment or a control by the gNB of the UE-side UL power utilization in certain slots is then not effectively supported based on existing technology. This can penalize an achievable UL coverage or UL throughput of the UE when a UE maximum output power is set by the UE indiscriminately of a time-domain resource for UL transmissions on the carrier.

Accordingly, embodiments of the present disclosure recognize that there is a need for separate control and/or adjustment of the UE transmitter power or UE maximum output power in a wireless communication system.

For simplicity of description, figures, or timelines, or embodiments for a separate UL duty cycle determination in a wireless communication system may be exemplified using a wireless communication system supporting full-duplex operation for illustration purposed. As can be seen by someone skilled-in-the-art, the considerations of the embodiments of the present disclosure can be extended to a wireless communication system without full-duplex operation.

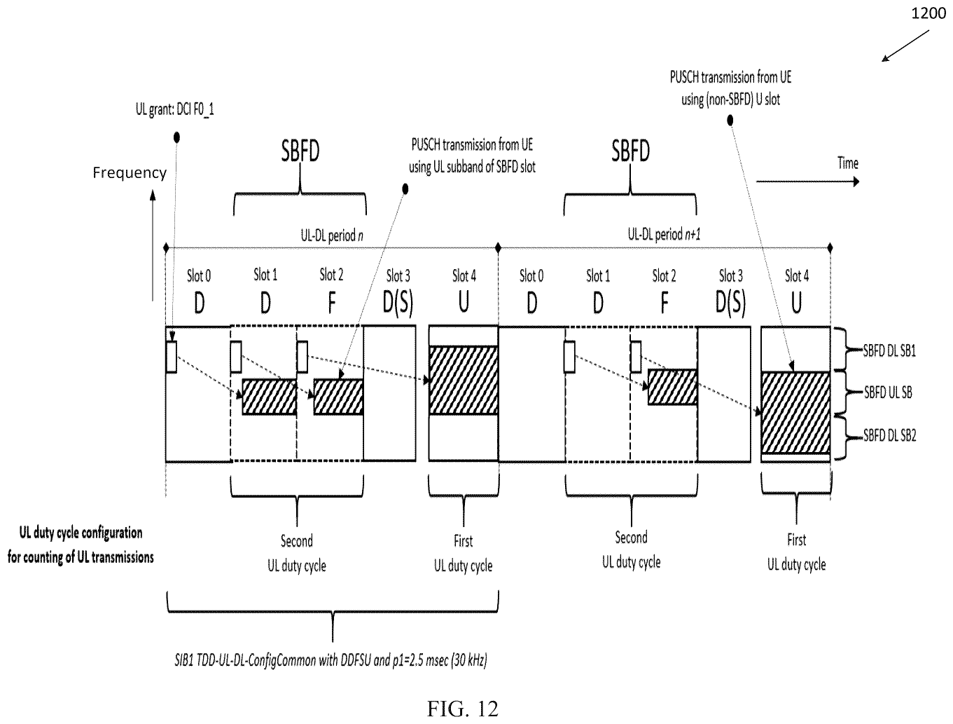

FIG. 12 illustrates a timeline 1200 of an example separate UL duty cycle determination according to embodiments of the present disclosure. For example, timeline 1200 can be followed by the UE 116 and the gNB 102 and/or network 130 in the wireless network 100 of FIG. 1. This example is for illustration only and other embodiments can be used without departing from the scope of the present disclosure.

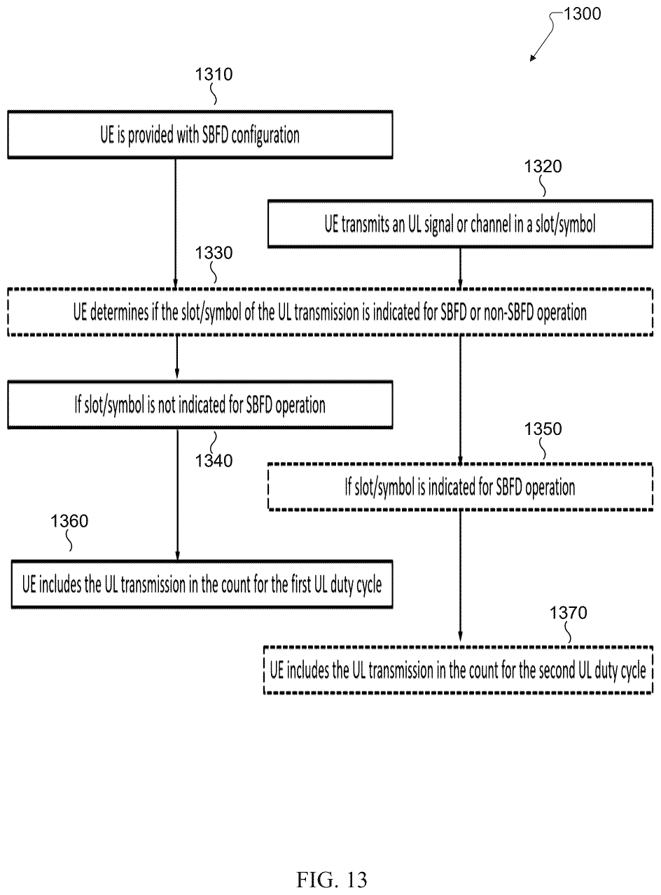

FIG. 13 illustrates flowchart of an example UE procedure 1300 for separate UL duty cycle determination according to embodiments of the present disclosure. For example, procedure 1300 can be performed by any of the UEs 111-116 of FIG. 1. This example is for illustration only and other embodiments can be used without departing from the scope of the present disclosure.

The procedure begins in 1310, a UE is provided with SBFD configuration. In 1320, the UE transmits an UL signal or channel in a slot/symbol. In 1330, the UE may determine whether the slot/symbol of the UL transmission is indicated for SBFD or non-SBFD operation. In 1340, the UE determines whether the slot/symbol is not indicated for SBFD operation. In 1350, the UE may determine whether the slot/symbol is indicated for SBFD operation. In 1360, the UE includes the UL transmission in the count for the first UL duty cycle. In 1370, the UE may include the UL transmission in the count for the second UL duty cycle.

In one embodiment the UE determines a first UL duty cycle associated with UL transmissions in non-SBFD slots/symbols and a second UL duty cycle associated with UL transmissions in SBFD slots/symbols, respectively. The UE separately evaluates the number of UL transmissions or the percentage of UL transmissions occurring in a period for an UL duty cycle associated with UL transmissions in the non-SBFD slots/symbols and an UL duty cycle in the SBFD slots/symbols, respectively, on a carrier or in a band.

In one embodiment the UE determines a first UL duty cycle associated with UL transmissions in a first set of slots/symbols and a second UL duty cycle associated with UL transmissions in a second set of slots/symbols, respectively, on the carrier or in a band. The UE separately evaluates the number of UL transmissions or the percentage of UL transmissions occurring in a period for an UL duty cycle associated with UL transmissions in the firsts set of slots/symbols and an UL duty cycle in the second set of slots/symbols, respectively, on a carrier or in a band. The first and the second set of symbols/slots on the carrier or in a band may be provided to the UE by the gNB or may be determined by the UE based on system operating specifications. For example, the first and the second set of symbols/slots may be disjoint sets, or may be partially overlapping sets.

In one example, the UE supports a maximum UL duty cycle associated with a UE Power Class. For simplicity of description and illustration purposes and without loss of generality, the example of an FR1 UE supporting PC2 on a serving cell with SBFD in NR band n78 is provided. The UE indicates or reports its supported PC, i.e., PC2, to the gNB as the power class the UE supports when operating according to this band combination using a parameter powerClass as part of the signaled UE radio access capability parameters. The UE indicates or reports to the gNB its associated supported UL duty cycle as the maximum percentage of symbols during a certain evaluation period that can be scheduled for UL transmission to ensure compliance with applicable electromagnetic energy absorption requirements provided by regulatory bodies using a parameter maxUplinkDutyCycle-PC2-FR1, e.g., with a value n60, or 60%, as part of the signaled UE radio access capability parameters. A number of UL transmissions over a period of time is scheduled or configured for the UE by the gNB wherein some UL transmissions are scheduled or configured using the SBFD UL subband of an SBFD slot/symbol and some UL transmissions are scheduled or configured in normal UL slot/symbols.

With reference to FIG. 12, when transmitting an UL signal or channel in a non-SBFD slot/symbol, e.g., a slot or symbol configured as U by RRC parameter TDD-UL-DL-ConfigCommon in SIB1 or parameter ServingCellConfigCommon, the UE counts the UL transmission with respect to a first UL duty cycle associated with UL transmissions in non-SBFD symbols but does not count the UL transmission with respect to a second UL duty cycle associated with UL transmissions in SBFD symbols. For example, the first UL percentage of UL symbols transmitted in the non-SBFD symbols, i.e., normal UL slot, is then determined by the UE (e.g., the UE 116) with reference to a certain evaluation period. When transmitting an UL signal or channel in the SBFD UL subband of an SBFD slot/symbol, e.g., a slot or symbol configured as D or F by RRC parameter TDD-UL-DL-ConfigCommon in SIB1 or parameter ServingCellConfigCommon, the UE counts the UL transmission with respect to a second UL duty cycle associated with UL transmissions in SBFD symbols but does not count the UL transmission with respect to the first UL duty cycle associated with UL transmissions in non-SBFD symbols. For example, the second UL percentage of UL symbols transmitted in the SBFD symbols, i.e., SBFD slot, is then determined by the UE with reference to a certain evaluation period.

For example, when a first and a second set of symbols/slots on the carrier or in a band is provided to the UE by the gNB or is determined by the UE, the UE counts the UL transmission with respect to a first UL duty cycle associated with UL transmissions in the first set of slots/symbols but does not count the UL transmission with respect to the second UL duty cycle associated with UL transmissions in the second set of slots/symbols, and the UE counts the UL transmission with respect to a second UL duty cycle associated with UL transmissions in the second set of slots/symbols but does not count the UL transmission with respect to the first UL duty cycle associated with UL transmissions in the first set of slots/symbols. Similar considerations for an evaluation period corresponding to the first or the second set of symbols/slots can be applied as illustrated for the example of SBFD operation.

For example, a value for an UL duty cycle for SBFD or non-SBFD symbols may correspond to a default UL duty cycle, e.g., 50%. The absence of a field or value indicative of a supported UL duty cycle other than the default UL duty cycle in the corresponding UE radio access capability parameters may imply that the UE supports the default UL duty cycle associated with a UE Power Class for UL transmissions in SBFD symbols. Alternatively, a supported UL duty cycle associated with SBFD symbols may be separately indicated or signaled as a value or a setting in the UE radio access capability parameters.

A default UL duty cycle may be a same or a different value when associated with SBFD symbols or with non-SBFD symbols, respectively. For example, a default UL duty cycle for non-SBFD symbols may correspond to a percentage X_{UL}=50% but a separate default UL duty cycle for SBFD symbols or a set of slots comprising an SBFD symbol may correspond to X_{SBFD}=70%. For example, a default UL duty cycle associated with SBFD symbols or a set of slots comprising an SBFD symbol and non-SBFD symbols may be indicated or tabulated or provided by system operating specifications. Furthermore, a default UL duty cycle for a UE Power Class in SBFD symbols may be further associated with additional conditions or restrictions as elaborated upon in the following.

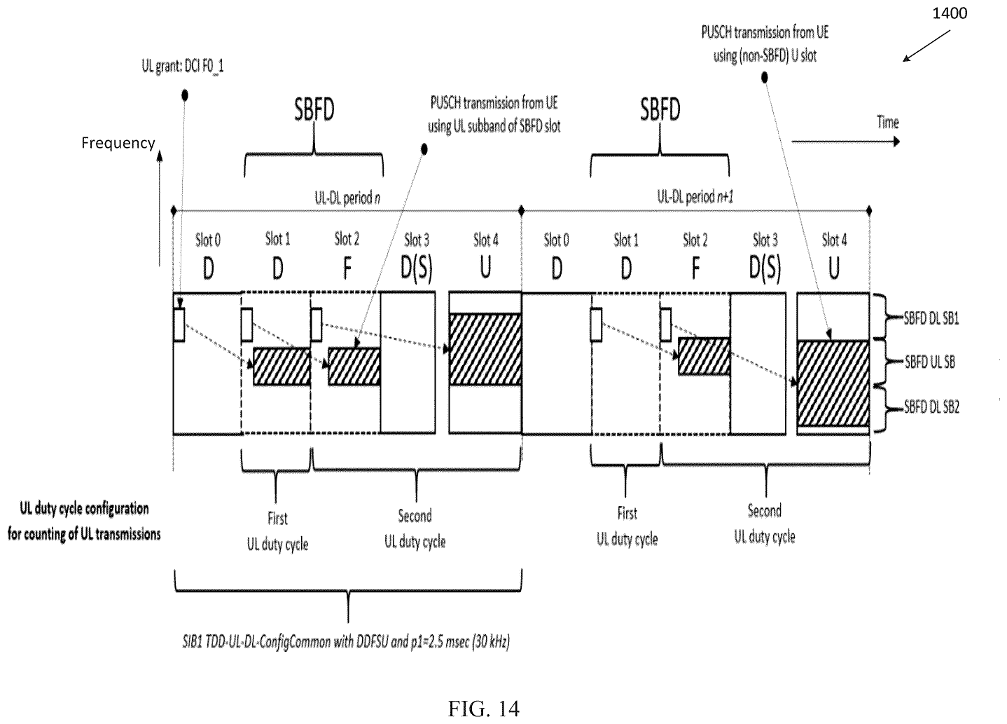

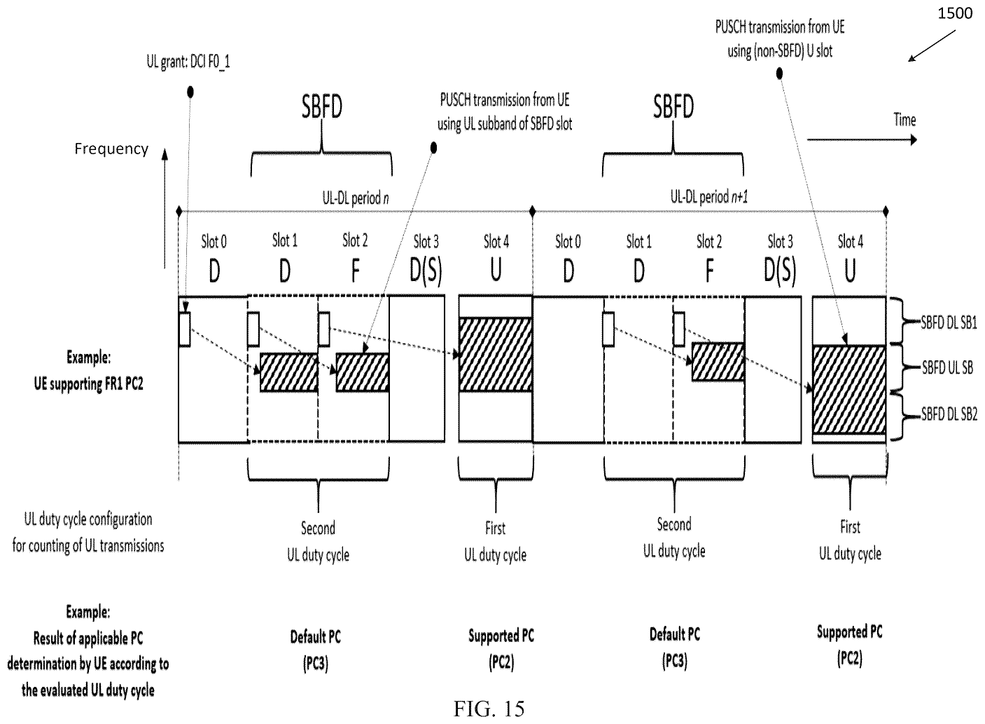

FIG. 14 illustrates a timeline 1400 of an example separate UL duty cycle determination according to embodiments of the present disclosure. For example, timeline 1400 can be followed by the UE 116 and the gNB 102 and/or network 130 in the wireless network 100 of FIG. 1. This example is for illustration only and other embodiments can be used without departing from the scope of the present disclosure.

Similar considerations can be extended to the case when the UE evaluates a first or a second UL duty cycle, or applies a default UL duty cycle, or is provided with a first or a second maximum supported UL duty cycle wherein a first UL duty cycle is associated with UL transmissions in a first set of slots/symbols and a second UL duty cycle is associated with UL transmissions in a second set of slots/symbols, respectively, on the carrier or in a band.

In one embodiment, the UE determines a first UL duty cycle associated with UL transmissions in a first set of SBFD slots/symbols and a second UL duty cycle associated with a second set of SBFD slots/symbols on a carrier or in a band, respectively. The UE separately evaluates the number of UL transmissions or the percentage of UL transmissions occurring in a period for an UL duty cycle associated with the UL transmissions in the first set of SBFD slots/symbols and an UL duty cycle in the second set of SBFD slots/symbols, respectively, on a carrier or in a band.

In one example and with reference to FIG. 11, when transmitting an UL signal or channel in a first SBFD slot/symbol, e.g., a slot or symbol configured as D by RRC parameter TDD-UL-DL-ConfigCommon in SIB1 or parameter ServingCellConfigCommon, the UE counts the UL transmission with respect to a first UL duty cycle associated with UL transmissions in SBFD symbols of symbol type ‘D’ but does not count the UL transmission with respect to a second UL duty cycle associated with UL transmissions in SBFD symbols of symbol type ‘F’. For example, the first UL percentage of UL symbols transmitted in the SBFD symbols of symbol type ‘D’, is then determined by the UE with reference to a certain evaluation period. When transmitting an UL signal or channel in the SBFD UL subband of an SBFD slot/symbol of type ‘F’, e.g., a slot or symbol configured as F by RRC parameter TDD-UL-DL-ConfigCommon in SIB1 or parameter ServingCellConfigCommon, the UE counts the UL transmission with respect to a second UL duty cycle associated with UL transmissions in SBFD symbols of symbol type ‘F’ but does not count the UL transmission with respect to the first UL duty cycle associated with UL transmissions in SBFD symbols of type ‘D’. For example, the second UL percentage of UL symbols transmitted in the SBFD symbols on symbol type ‘F’ is then determined by the UE with reference to a certain evaluation period.

In one embodiment, the UE determines a first UL duty cycle associated with UL transmissions in a first set of slots/symbols and a second UL duty cycle associated with a second set of slots/symbols on a carrier or in a band, respectively, wherein the first or the second set can comprise a combination of SBFD and non-SBFD symbols. For example, the first set may comprise SBFD symbols and the second set SBFD and non-SBFD symbols, or the first and the second sets each both comprise SBFD and non-SBFD symbols. The UE separately evaluates the number of UL transmissions or the percentage of UL transmissions occurring in a period for an UL duty cycle associated with the UL transmissions in the first set of slots/symbols and an UL duty cycle in the second set of slots/symbols, respectively, on a carrier or in a band.

In one example and with reference to FIG. 14, the UE separately evaluates a first UL duty cycle associated with UL transmissions in SBFD slot #1 and a second UL duty cycle associated with UL transmissions in SBFD slot #2 or the normal UL slot #4. The UE counts the UL transmission with respect to a first UL duty cycle of the first set of slots/symbols associated with UL transmissions in SBFD slot #1 but does not count the UL transmission with respect to a second UL duty cycle of the second set of slots/symbols associated with UL transmissions in SBFD slot #2 or the normal UL slot #4. For example, the first UL percentage of UL symbols transmitted in the first set of slots/symbols, i.e., SBFD slot #1 is then determined by the UE with reference to a certain evaluation period. When transmitting an UL signal or channel in the SBFD UL subband of the SBFD slot #2 or the normal UL slot #4, the UE counts the UL transmission with respect to the second UL duty cycle of the second set of slots/symbols associated with UL transmissions in SBFD slot #2 and the normal UL slot #4 but does not count the UL transmission with respect to the first UL duty cycle of the first set of slots/symbols associated with UL transmissions in SBFD slot #1. For example, the first UL percentage of UL symbols transmitted in the second set of slots/symbols, i.e., SBFD slot #2 or the normal UL slot #4, is then determined by the UE with reference to a certain evaluation period.

A motivation is that a separate determination by the UE of a first and a second UL duty cycle associated with non-SBFD symbols and SBFD symbols, respectively, enables the full-duplex capable base station to separately control and adjust the UE behavior for PC fallback or P-MPR based mitigation in SBFD slots and the non-SBFD slots, respectively. This can benefit the achievable UL coverage or UL data rate. Another motivation is that a separate determination by the UE of a first and a second UL duty cycle associated with a first and a second set of slots or symbols, respectively, on a carrier or in a band enables the base station to separately control and adjust the UE behavior for PC fallback or P-MPR based mitigation in the first set of slots and the second set of slots, respectively, on the carrier or in the band. This can benefit the achievable UL coverage or UL data rate when a separate PC fallback or separate P-MPR based mitigation behavior is desired on the carrier for a higher power class UE to adjust for a use of an UL transmission scheme such as FDSS.

For example, when a non-SBFD slot/symbol such as a normal UL slot/symbol benefiting from less interference at the gNB (e.g., the BS 102) and/or lower target receive power settings than the UL subband in SBFD slots/symbols is used for UL transmissions from the UE, it may be preferable to not reduce the UE maximum output power in such a normal UL slot/symbol. This is because for some SBFD antenna configurations, more SINR per slot/symbol can often be collected by the gNB in a non-SBFD slot/symbol than in an SBFD slot/symbol of the full-duplex cell. If the UE reduces a maximum output power based on PC fallback or P-MPR based mitigation procedures, for example to comply with electromagnetic energy absorption requirements, the maximum output power should preferably not be reduced as a function of the UL duty cycle corresponding to any UL transmission, i.e., across any UL slot/symbol type, but rather be set and adjusted first with respect to the UL duty cycle only in non-SBFD symbols where a higher transmit power may be employed.

In another example, for some SBFD antenna configurations, it may be more advantageous to employ a same UE maximum output power for UL transmissions from the UE across the non-SBFD and SBFD slots/symbols such as when the Joint Channel Estimation (JCE) feature with PUSCH or PUCCH repetition is configured. When the UE reduces a maximum output power based on PC fallback or P-MPR based mitigation procedures for example to comply with electromagnetic energy absorption requirements, different UE maximum output power settings across slots can result, the phase coherency cannot be preserved, the gNB-side channel estimation gain from the JCE feature is degraded, and UL coverage is correspondingly reduced. It is then preferable to set and adjust the UE maximum output power with respect to the UL duty cycle corresponding to the JCE slots, i.e., across a set of slots comprising SBFD and/or non-SBFD symbols where a same transmit power should be employed.

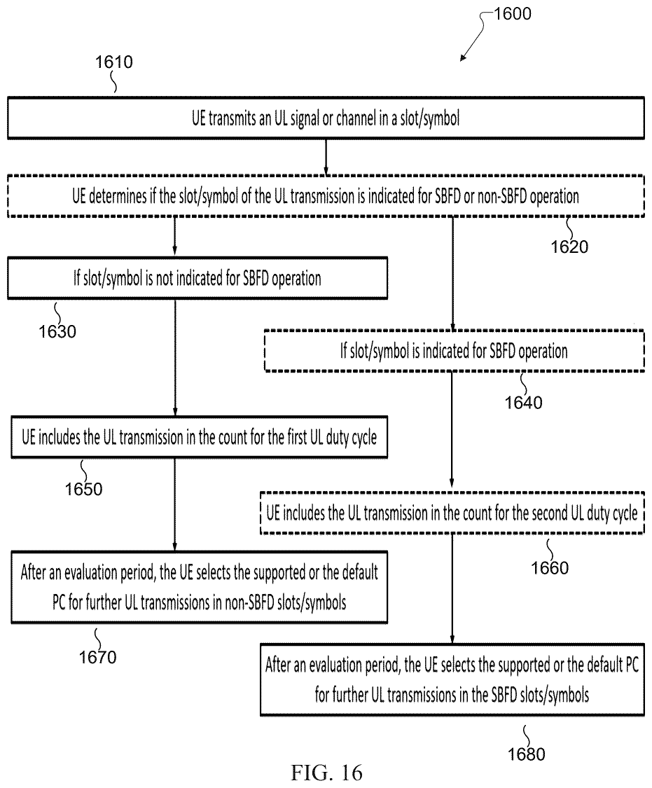

FIG. 15 illustrates a timeline 1500 of an example PC determination based on separate UL duty cycles 1500 according to embodiments of the present disclosure. For example, PC determination based on separate UL duty cycles 1500 can be followed by the UE 116 and the gNB 103 and/or network 130 in the wireless network 100 of FIG. 1. This example is for illustration only and other embodiments can be used without departing from the scope of the present disclosure.

FIG. 16 illustrates flowchart of an example UE procedure 1600 for PC determination based on separate UL duty cycles according to embodiments of the present disclosure. For example, procedure 1600 can be performed by any of the UEs 111-116 of FIG. 1, such as the UE 116. This example is for illustration only and other embodiments can be used without departing from the scope of the present disclosure.

The procedure begins in 1610, a UE transmits an UL signal or channel in a slot/symbol. In 1620, the UE may determine whether the slot/symbol of the UL transmission is indicated for SBFD or non-SBFD operation. In 1630, the UE determines whether slot/symbol is not indicated for SBFD operation. In 1640, the UE may determine whether slot/symbol is indicated for SBFD operation. In 1650, the UE includes the UL transmission in the count for the first UL duty cycle. In 1660, the UE may include the UL transmission in the count for the second UL duty cycle. In 1670, after an evaluation period, the UE selects the supported or the default PC for further UL transmissions in non-SBFD slots/symbols. In 1680, after an evaluation period, the UE selects the supported or the default PC for further UL transmissions in the SBFD slots/symbols.

In one embodiment the UE further determines a UE Power Class or a power reduction value for a UE maximum output power or for an UL transmission power based on a first UL duty cycle or a second UL duty cycle, respectively, wherein the first and/or the second UL duty cycle are associated with UL transmissions on SBFD symbols or non-SBFD symbols on the serving cell.

In one embodiment the UE further determines a UE Power Class or a power reduction value for a UE maximum output power or for an UL transmission power based on a first UL duty cycle or a second UL duty cycle, respectively, wherein the first and/or the second UL duty cycle are associated with UL transmissions in a first or a second set of slots/symbols, respectively, on the serving cell.

With reference to the example of an FR1 UE indicating support for PC2 on a serving cell with SBFD in the NR band n78, following a number of scheduled or configured UL transmissions, the UE separately determines a first UL duty cycle as a percentage of UL transmissions occurring in a certain evaluation period in the non-SBFD slots/symbols and a second UL duty cycle as percentage of UL transmissions occurring in a certain evaluation in the SBFD slots/symbols. For example, a first UL duty cycle determined by the UE on non-SBFD symbols may result in a percentage, e.g., X_{non-SBFD}=20% but a separate second UL duty cycle for SBFD symbols or a set of slots comprising an SBFD symbol may correspond in another or same percentage, e.g., X_{SBFD}=60% with respect to a certain evaluation period.

In one example, the UE then selects a UE Power Class or a power reduction value to determine a UE maximum output power or an UL transmission power associated with UL transmissions in non-SBFD slots/symbols and with UL transmissions in the SBFD UL subband of SBFD slots/symbols, respectively. For example, the UE may compare a value determined for the first UL duty cycle, e.g., X_{non-SBFD}=20% to a first threshold value, e.g., X_{non-SBFD}. TH=30% or the UE may compare a value determined for the second UL duty cycle, e.g., X_{SBFD}=60% to a second threshold value, e.g., X_{SBFD, TH}=50%. The first and the second threshold values be a same value or different values. A second threshold value may be determined based on a first threshold value and an adjustment factor. For example, when the supported UE Power Class enables the higher maximum output power than that of the default power class, the UE selects a configured transmitted power according to the default power class when the value of an UL duty cycle is higher than a threshold value, and the UE selects a configured transmitted power according to the supported power class when the value of an UL duty cycle is smaller than and/or equal to a threshold value.

For example, when a first and a second set of symbols/slots on the carrier or in a band is provided to the UE by the gNB or is determined by the UE, the UE then selects a UE Power Class or a power reduction value to determine a UE maximum output power or an UL transmission power associated with UL transmissions in the first set of slots/symbols and with UL transmissions in the second set of slots/symbols, respectively. For example, the UE may compare a value determined for the first UL duty cycle, e.g., Xₛₑₜ₁=20% to a first threshold value, e.g., X_{set1, TH}=30% or the UE may compare a value determined for the second UL duty cycle, e.g., Xₛₑₜ₂=60% to a second threshold value, e.g., X_{set2,TH}=50%. For example, when the supported UE Power Class enables the higher maximum output power than that of the default power class, the UE selects a configured transmitted power according to the default power class when the value of an UL duty cycle is higher than a threshold value, and the UE selects a configured transmitted power according to the supported power class when the value of an UL duty cycle is smaller than and/or equal to a threshold value.

For example, when a UE supports a different power class, i.e., PC2, from the default UE power class for the band and the supported power class enables the higher maximum output power than that of the default power class, if the field of UE capability maxUplinkDutyCycle-PC2-FR1 is absent and the percentage of UL symbols transmitted in a certain evaluation period on SBFD symbols is larger than X_{SBFD, TH}, or the percentage of UL symbols transmitted in a certain evaluation period on non-SBFD symbols is larger than X_{non-SBFD}. TH or if the field of UE capability max (plinkDutyCycle-PC2-FR1 is not absent and the percentage of UL symbols transmitted in a certain evaluation period on SBFD symbols is larger than maxUplinkDutyCycle-PC2-FR1, or the percentage of UL symbols transmitted in a certain evaluation period on non-SBFD symbols is larger than max (plinkDutyCycle-PC2-FR1, the UE then applies requirements for the default power class to the supported power class, e.g., PC3, for the corresponding symbols of type SBFD or non-SBFD, respectively, and sets the configured transmitted power accordingly; else the UE applies requirements for the supported power class; and sets the configured transmitted power as further defined in REF7.

For the example herein, with example values X_{non-SBFD}=20%, X_{non-SBFD, TH}=30%, X_{SBFD}=60% and X_{SBFD, TH}=50%, the UE would then determine a use of the default PC3 for the SBFD slot and a use of the supported (higher) PC2 for the non-SBFD or UL slot, respectively, when determining a configured transmitted output power according to the example.

Similar instances can be applied with respect to determination or selection of a power reduction value with UL transmissions in non-SBFD slots/symbols and with UL transmissions in the SBFD UL subband of SBFD slots/symbols, respectively. For example, a power reduction value may correspond to a value P-MPR. For the example herein, with example values X_{non-SBFD}=20%, X_{non-SBFD, TH}=30%, X_{SBFD}=60% and X_{SBFD}. TH=50%, the UE would then determine a first value P-MPR_{non-SBFD}, e.g., 0 dB, for the non-SBFD or UL slot and a second value P-MPR_{SBFD}, e.g., −3 dB, for the SBFD slot, respectively, when determining a configured transmitted output power.

Similar instances based on previous example can be applied to other cases such as UE determination of a first UL duty cycle associated with UL transmissions in a first set of slots/symbols and a second UL duty cycle associated with a second set of slots/symbols on a carrier or in a band, respectively, or when the first or the second set of symbols/slots can comprise a combination of SBFD and non-SBFD symbols/slots, or to other cases such as UE Power Classes other than the example PC2 such as PC1.5 or PC1, or to other cases such as UE operation in FR1, FR2 or FR3 to determine a UE maximum output power or an UL transmission power.

Similar considerations can be extended to the case when the UE evaluates a first or a second UL duty cycle, or applies a default UL duty cycle, or is provided with a first or a second maximum supported UL duty cycle wherein a first UL duty cycle is associated with UL transmissions in a first set of slots/symbols and a second UL duty cycle is associated with UL transmissions in a second set of slots/symbols, respectively, on the carrier or in a band, to set a UE maximum output power, or to determine a configured UE maximum transmit power, or to apply a power-class fallback or P-MPR based operation.

In one embodiment, the UE determines an UL duty cycle associated with UL transmissions in a set of symbols/slots on a carrier or in a band based on a condition or restriction. For example, the set of symbols/slots may comprise only SBFD symbols, or only non-SBFD symbols, or may comprise a combination of SBFD and non-SBFD symbols on a carrier in a band. For example, the UE may be provided with a first and/or a second set of symbols/slots on the carrier or in the band.

For example, an UL duty cycle for UL transmissions in a set of slots/symbols on a serving cell may be associated with one or more of the following conditions or restrictions:
A symbol or slot type, e.g., symbol/slot of type SBFD, or of type ‘non-SBFD’, or symbol/slot type ‘D’ or ‘F’ or ‘U’
An SBFD subband type, e.g., SBFD DL subband and/or SBFD UL subband and/or first SBFD DL subband and/or second SBFD DL subband and/or SBFD flexible subband.
A size or a location of an SBFD subband, e.g., SBFD UL subband with size smaller or larger than a number of RBs.
A type or an identifier of an SBFD configuration, e.g., ‘DU’, or ‘UD’, or ‘DUD’. A TRP or TRPs, e.g., TRP A and/or TRP B, or a CORESETPoolIndex associated with CORESETs for PDCCH receptions, or a TRP identified by one or more SS/PBCH blocks (SSBs).
A number of symbol or slots, e.g., number of consecutive symbols or slots, or number of symbols or slots in a period.
A set of symbols/slots, e.g., an identifier, or a bitmap, or a list of symbols/slots, or a resource indicator value such as SLIV with starting slot/symbol value and a run length value in an index representation.
An UL signal or channel type, e.g., PUCCH, PUSCH, PRACH or SRS.
A maximum or a minimum value, e.g., a minimum SBFD UL subband size, or a minimum length in number of symbols of a PUSCH or PUCCH time-domain resource allocation, or a maximum number of SBFD symbols in a slot.
A transmission power, e.g., a maximum, a minimum, or a range of UE output power or configured transmission power or UL transmit power level.
A serving cell index associated with a carrier aggregation or dual-connectivity configuration.
A timing value, e.g., a start or end time, or a duration, or a validity period.

In one example for an FR1 UE indicating support for PC2 on a serving cell with SBFD in the NR band n78, the UE determines an UL duty cycle for a set of SBFD slots/symbols as a percentage of UL transmissions occurring in a certain evaluation period in the configured or indicated SBFD slots/symbols wherein the additional condition is ‘slot type=SBFD’ and ‘symbol type=‘D’. When transmitting an UL signal or channel in the SBFD UL subband of an SBFD slot, the UE counts the UL transmission with respect to the UL duty cycle if the UL transmission occurred on a configured or indicated SBFD slot and a slot or symbol configured as ‘D’ by RRC parameter TDD-UL-DL-ConfigCommon in SIB1 or parameter ServingCellConfigCommon. For example, the UE then does not count the UL transmission with respect to the UL duty cycle if the UL transmission occurred on a configured or indicated SBFD slot and occurred on a slot or symbol configured as ‘F’ by RRC parameter TDD-UL-DL-ConfigCommon in SIB1 or parameter ServingCellConfigCommon.

In another example for an FR1 UE indicating support for PC2 on a serving cell with SBFD in the NR band n78, the UE determines an UL duty cycle for a set of SBFD slots/symbols as a percentage of UL transmissions occurring in a certain evaluation period in the configured or indicated SBFD slots/symbols wherein the additional condition is ‘minimum time-domain allocation size of the UL transmission equal or less than 2 symbols’. For example, when transmitting an UL signal or channel in the SBFD UL subband of an SBFD slot, the UE counts the UL transmission with respect to the UL duty cycle if the UL transmission occurred on a configured or indicated SBFD slot and PUSCH, e.g., ≥4 symbols, is transmitted. For example, the UE then does not count the UL transmission with respect to the UL duty cycle if the UL transmission occurred on a configured or indicated SBFD slot and PUCCH Format 0 is transmitted.

In another example, the UE determines a first and a second UL duty as a percentage of UL transmissions occurring in a certain evaluation period wherein the additional condition is “a set of symbol/slot identifiers”. For example, the first UL duty cycle for a serving cell may be associated with UL transmissions of a PUCCH, PUSCH, SRS or PRACH by the UE in a first set of slots on the serving cell. The second UL duty cycle for a serving cell may be associated with UL transmissions of a PUCCH, PUSCH, SRS or PRACH by the UE in a second set of slots on the serving cell. The first and second set of slots on the serving cell may be referred to as a first Transmission Slot/Symbol Group TSG₁ and a second Transmission Slot/Symbol Group TSG₂. For example, the first and the second set of slots on the serving cell may be configured or indicated to the UE as corresponding to a first set of slots/symbols and corresponding to a second set of slots/symbols, respectively. A UE may be configured with one or more Transmission Slot/Symbol Group(s) (TSG(s)) for a serving cell to determine an UL duty cycle wherein a TSG is a set of selected or identified slots/symbols of a serving cell associated with a same counting procedure to determine a number or a percentage of UL transmissions in a certain evaluation period on the set of symbols/slots corresponding to the TSG. For example, a set of symbol/slot identifiers associated with a TSG may correspond to a bitmap or a list of slots/symbols or a SLIV value with a start and run length number of slots/symbols. For example, a set of symbol/slot identifiers associated with a TSG may be indicated to the UE by DCI or provided to the UE by higher layer signaling, e.g., RRC or by MAC CE.

Similar instances can be applied to other cases such as when the condition or restriction does not correspond to an inclusion but corresponds to an exclusion rule. For example, the UE may determine an UL duty cycle for a set of SBFD slots/symbols as a percentage of UL transmissions occurring in a certain evaluation period in the configured or indicated SBFD slots/symbols wherein the additional condition is ‘slot type=SBFD’ and ‘not symbol type=‘D’. When transmitting an UL signal or channel in the SBFD UL subband of an SBFD slot, the UE counts the UL transmission with respect to the UL duty cycle if the UL transmission occurred on a configured or indicated SBFD slot and a slot or symbol configured as ‘F’ by RRC parameter TDD-UL-DL-ConfigCommon in SIB1 or parameter ServingCellConfigCommon. For example, the UE then does not count the UL transmission with respect to the UL duty cycle if the UL transmission occurred on a configured or indicated SBFD slot and occurred on a slot or symbol configured as ‘D’ by RRC parameter TDD-UL-DL-ConfigCommon in SIB1 or parameter ServingCellConfigCommon.

In one embodiment, the UE (e.g., the UE 116) is provided with a configurable adjustment value with respect to a suitably chosen reference allowing to determine an adjusted or assumed UL duty cycle associated with UL transmissions in a set of symbols/slots on a carrier or in a band.

For example, the set of symbols/slots may comprise only SBFD symbols, or only non-SBFD symbols, or may comprise a combination of SBFD and non-SBFD symbols on a carrier in a band. For example, the set of symbols/slots may correspond to a first or a second set of slots or symbols on a carrier in a band. For example, the adjustment value may correspond to a scaling value, or an offset value, or a threshold value. For example, an adjusted or assumed value for an UL duty cycle may be determined with reference to the same UL duty cycle or a different UL duty cycle. For example, UL transmissions may correspond to PUSCH, PUCCH, PRACH or SRS.

In one example, the UE selects a UE Power Class or a power reduction value to determine a UE maximum output power or an UL transmission power associated with UL transmissions in non-SBFD slots/symbols or with UL transmissions in the SBFD UL subband of SBFD slots/symbols, respectively, based on an assumed or an adjusted UL duty cycle. The UE is provided with a scaling value S_{SBFD}, e.g., 50%, to determine an adjusted or assumed UL duty cycle with reference to the same UL duty cycle. Following a number of scheduled or configured UL transmissions, the UE separately determines a first UL duty cycle as a percentage of UL transmissions occurring in a certain evaluation period in the non-SBFD slots/symbols and a second UL duty cycle as percentage of UL transmissions occurring in a certain evaluation in the SBFD slots/symbols. For example, a first UL duty cycle determined by the UE on non-SBFD symbols may result in a percentage, e.g., X_{non-SBFD}=20% but a separate second UL duty cycle for SBFD symbols or a set of slots comprising an SBFD symbol may correspond in another or same percentage, e.g., X_{SBFD}=60% with respect to a certain evaluation period. The UE applies the scaling value S_{SBFD}=50% to the second UL duty cycle for SBFD symbols, X_{SBFD}=60%, to determine an adjusted or assumed UL duty cycle for SBFD symbols, e.g., X_{SBED_eff}=S_{SBFD} X_{SBFD}=30%. For example, the UE may then compare the value determined for the first UL duty cycle, e.g., X_{non-SBFD}=20% to a first threshold value, e.g., X_{non-SBFD}. TH=30% or the UE may compare the adjusted or assumed value determined for the second UL duty cycle, e.g., X_{SBFD_eff}=30% to a second threshold value, e.g., X_{SBFD, TH}=50%. For the example herein, with example values X_{non-SBFD}=20%, X_{non-SBFD, TH}=30%, X_{SBFD}=60%, X_{SBFD, TH}=50%, and S_{SBFD}=50% the UE would then determine a use of the PC2 for the SBFD slot and a use of the supported PC2 for the non-SBFD or UL slot, respectively, when determining a configured transmitted output power.

Similar considerations can be extended to the case when the UE selects a UE Power Class or a power reduction value to determine a UE maximum output power or an UL transmission power associated with UL transmissions in a first set of slots/symbols or with UL transmissions in the second set of slots/symbols, respectively, based on an assumed or an adjusted UL duty cycle.

In another example, the UE selects a UE Power Class or a power reduction value to determine a UE maximum output power or an UL transmission power associated with UL transmissions in non-SBFD slots/symbols or with UL transmissions in the SBFD UL subband of SBFD slots/symbols, respectively, based on an assumed or an adjusted UL duty cycle. The UE is provided with a scaling value S_{SBFD}, e.g., 2, to determine an adjusted or assumed UL duty cycle with reference to another UL duty cycle. Following a number of scheduled or configured UL transmissions, the UE separately determines a first UL duty cycle as a percentage of UL transmissions occurring in a certain evaluation period in the non-SBFD slots/symbols and based on the adjustment value and the first UL duty cycle further determines an assumed or adjusted value for a second UL duty cycle. For example, a first UL duty cycle determined by the UE on non-SBFD symbols may result in a percentage, e.g., X_{non-SBFD}=20%. The UE applies the scaling value S_{SBFD}=50% to the first UL duty cycle for non-SBFD symbols, X_{non-SBFD}=20%, to determine an adjusted or assumed UL duty cycle for SBFD symbols, e.g., X_{SBFD_eff}=S_{SBFD} X_{non-SBFD}=40%. For example, the UE may then compare the value determined for the first UL duty cycle, e.g., X_{non-SBFD}=20% to a first threshold value, e.g., X_{non-SBFD, TH}=30% or the UE may compare the adjusted or assumed value determined for the second UL duty cycle, e.g., X_{SBFD_eff}=40% to a second threshold value, e.g., X_{SBFD, TH}=50%. For the example herein, with example values X_{non-SBFD}=20%, X_{non-SBFD, TH}=30%, X_{SBFD, TH}=50%, and S_{SBFD}=2 the UE would then determine a use of the PC2 for the SBFD slot and a use of the supported PC2 for the non-SBFD or UL slot, respectively, when determining a configured transmitted output power.

Similar instances based on the examples can be applied to other cases such as UE determination of a first UL duty cycle associated with UL transmissions in a first set of slots/symbols and a second UL duty cycle associated with a second set of slots/symbols on a carrier or in a band, respectively, wherein the first or the second set can comprise a combination of SBFD and non-SBFD symbols, or to other cases such as UE Power Classes other than the example PC2 such as PC1.5 or PC1, or to other cases such as UE operation in FR1, FR2 or FR3 to determine a UE maximum output power or an UL transmission power.

In one embodiment, the UE is provided with a configuration or an indication for parameters associated with an UL duty cycle to determine a number or percentage of UL transmissions for a set of symbols/slots on a carrier or in a band.

For example, the set of symbols/slots may comprise only SBFD symbols, or only non-SBFD symbols, or may comprise a combination of SBFD and non-SBFD symbols on a carrier in a band. For example, the set of symbols/slots may correspond to a first or a second set of slots or symbols on a carrier in a band. For example, parameters may correspond to one or more of conditions or restrictions or adjustment value or an evaluation period as described by other embodiments. For example, a configuration of a parameter value or a set of parameter values may be provided from the gNB (e.g., the BS 102) to the UE by higher layer signaling, e.g., RRC or by MAC CE, and/or indicated to the UE by DCI signaling. For example, a parameter value or a set of parameter values associated with an UL duty cycle may be tabulated and/or listed by system operating specifications.

In one example, a parameter associated with an UL duty cycle to determine a number or percentage of UL transmissions for a set of symbols/slots on a serving cell with SBFD may indicate the associated slot/symbols, the UL signal or channel type and/or evaluation period to a UE.

For example, one of or a combination of DCI-based, L1 control signaling, RRC signaling, MAC CE based signaling, and/or configuration may be used to provide the UE with a configuration or indication of a parameter associated with an UL duty cycle. For example, parameters associated with an UL duty cycle may be tabulated and/or listed by system operating specifications. If a same parameter associated with an UL duty cycle is provided for multiple UEs, a common DCI or common RRC signaling message may be used. A UE-specific DCI or RRC signaling of dedicated or common type may be used to provide a parameter value to a UE. A parameter value or set of parameter values associated with the UL duty cycle in a serving cell may be determined by the UE by means of providing an index value through DCI signaling and the UE selecting one or more entries from an RRC configurable table using the provided index value. For example, a PUSCH time-domain resource allocation table may be configured for the UE and include a parameter associated with an UL duty cycle to determine a number or percentage of UL transmissions for a set of symbols/slots on a carrier or in a band. For example, the UE may be indicated an entry of a PUSCH time-domain resource allocation table associated with a parameter corresponding to an UL duty cycle based on the TDRA field in a DCI format. The UE may determine a default value for a parameter value associated with an UL duty cycle. A DL reference signal with respect to the DL power adjustment of PDSCH, PDCCH or DMRS, phase tracking reference signal (PTRS) may be associated with or linked as TCI state(s) or RS resource index(es) corresponding to an SSB or to a CSI-RS resource index. An UL reference signal or channel or UL reference transmission format or power level may be configured for or indicated to the UE to determine parameters for an UL duty cycle on the serving cell with full-duplex.

In one embodiment the UE determines a first evaluation period for a first UL duty cycle associated with UL transmissions in non-SBFD slots/symbols and a second evaluation period for a second UL duty cycle associated with UL transmissions in SBFD slots/symbols, respectively.

In one embodiment the UE determines a first evaluation period for a first UL duty cycle associated with UL transmissions in a first set of slots/symbols and a second evaluation period for a second UL duty cycle associated with UL transmissions in a second set of slots/symbols, respectively.

The UE separately evaluates the number of UL transmissions or the percentage of UL transmissions occurring based on the first evaluation period for an UL duty cycle associated with UL transmissions such as in the non-SBFD slots/symbols and based on the second evaluation period for an UL duty cycle such as in the SBFD slots/symbols, respectively, on a carrier or in a band.

In a variation, the UE determines a first evaluation period for a first UL duty cycle associated with UL transmissions in a first set of slots/symbols and a second evaluation period for a second UL duty cycle associated with a second set of slots/symbols on a carrier or in a band, respectively. For example, the first or the second set can comprise a combination of SBFD and non-SBFD symbols. For example, the first or the second set can be provided to the UE as a set of slots or symbols. For example, the first set may comprise SBFD symbols and the second set may comprise SBFD and non-SBFD symbols, or the first and the second sets each both comprise SBFD and non-SBFD symbols. The UE separately evaluates the number of UL transmissions or the percentage of UL transmissions for an UL duty cycle associated with the UL transmissions in the first set of slots/symbols based on the first evaluation period and an UL duty cycle in the second set of slots/symbols based on the second evaluation period, respectively, on a carrier or in a band.

In a variation, the UE determines a first evaluation period associated with UL transmissions in a first set of slots/symbols and a second evaluation period associated with a second set of slots/symbols on a carrier or in a band, respectively. For example, the first or the second set of slots/symbols can comprise a combination of SBFD and/or non-SBFD symbols. For example, the first set may comprise SBFD symbols and the second set may comprise SBFD and non-SBFD symbols, or the first and the second sets each both comprise SBFD and non-SBFD symbols. For example, the first or the second set can be provided to the UE as a set of slots or symbols. The UE evaluates the number of UL transmissions or the percentage of UL transmissions occurring for the UL duty cycle associated with the UL transmissions in the first set of slots/symbols based on the first evaluation period and in the second set of slots/symbols based on the second evaluation period, respectively, on a carrier or in a band.

A value for a first and a second evaluation period may be a same or a different value when associated with SBFD symbols or with non-SBFD symbols or with the first and second set of slots/symbols, respectively. For example, a value for an evaluation period may correspond to time period or a duration, or may correspond to a threshold value. For example, a value for a second evaluation period may be determined based on the value for a first evaluation period and a scaling value, or an offset value, or a threshold value. For example, an adjusted or assumed value for the second evaluation period associated with an UL duty cycle may be determined with reference to another UL duty cycle. For example, a value for an evaluation period associated with an UL duty cycle of a set of slots/symbols comprising an SBFD symbol may be defined with reference to a minimum value, e.g., at least, or a maximum value, e.g., not exceeding, or a range of values, e.g., not less than X msec but not exceeding Y msec.

In one example, an evaluation period for the UL duty cycle for non-SBFD symbols on a serving cell may correspond to a minimum value, e.g., T_{eval,non-SBFD}=1 msec but a separate evaluation period for SBFD symbols or a set of slots comprising an SBFD symbol on the serving cell may correspond to T_{eval,SBFD}=0.5 msec. For example, a default value for an evaluation period associated with SBFD symbols or a set of slots comprising an SBFD symbol and non-SBFD symbols may be indicated or tabulated or provided by system operating specifications. Furthermore, a default value for an evaluation period associated with an UL duty cycle on a set of symbols/slots comprising an SBFD symbol may be provided or indicated to the UE or tabulated by system operating specifications.

In one embodiment, the UE indicates or reports separate values for a supported UL duty cycle corresponding to UL transmissions on SBFD slots/symbols and UL transmissions on non-SBFD slots/symbols, respectively, on a carrier or in a band. The UE indicates or reports a first supported UL duty cycle associated SBFD slots/symbols and a second supported UL duty cycle associated with non-SBFD slots/symbols.

In a variation, the UE indicates or reports separate values for a first supported UL duty cycle associated with UL transmissions in a first set of slots/symbols and a second supported UL duty cycle associated with a second set of slots/symbols on a carrier or in a band, respectively. For example, the first or the second set can comprise a combination of SBFD and non-SBFD symbols. For example, the first set may comprise SBFD symbols, and the second set may comprise SBFD and non-SBFD symbols, or the first and the second set each both comprise SBFD and non-SBFD symbols. For example, the first or the second set can be provided to the UE as a set of slots or symbols.

In one example, the UE supports a separate UL duty cycle for UL transmissions on SBFD slots/symbols and for UL transmissions on non-SBFD slots/symbols, respectively, on a carrier or in a band. Without loss of generality and for illustration purposes, SBFD operation in NR band n78 and FR1 UE PC2 are used as example. As part of its band or band combination capabilities, the UE declares or indicates support for a first UL duty cycle associated with its indicated power class, e.g., when operating on this band in SBFD slots/symbols using a parameter maxUplinkDutyCycle-PC2-FR1_SBFD but the UE declares or indicates support for a second associated UL duty cycle using parameter max UplinkDutyCycle-PC2-FR1 when operating in non-SBFD slots/symbols on that same band. For example, maxUplinkDutyCycle-PC2-FR1_SBFD=60% and maxUplinkDutyCycle-PC2-FR1=25%.

In another example, the UE supports a separate UL duty cycle for UL transmissions on a set of slots/symbols not comprising an SBFD symbol and for UL transmissions on the set of slots/symbols comprising an SBFD symbol, respectively, on a carrier or in a band. As part of its band or band combination capabilities, the UE declares or indicates support for a first UL duty cycle associated with the indicated or reported power class, e.g., for UL transmissions in the set of slots/symbols and the case these slots/symbols are non-SBFD slots/symbols using a parameter maxUplinkDutyCycle-PC2-FR1 but the UE declares or indicates support for a second associated UL duty cycle for the power class using parameter maxUplinkDutyCycle-PC2-FR1_SBFD when UL transmissions in the set of slots/symbols include an SBFD symbol on the carrier or the band. For example, max UplinkDutyCycle-PC2-FR1_SBFD=60% and max UplinkDutyCycle-PC2-FR1=40%.

In a variation, the UE indicates or reports a first value for a supported UL duty cycle for an associated power class and corresponding to UL transmissions on a serving cell when the cell is configured or indicated for SBFD operation and the UE indicates or reports a second value for a supported UL duty cycle on the serving cell when the cell is not configured or indicated with SBFD operation.

In a variation, the UE indicates or reports a first value for a supported UL duty cycle for an associated power class and corresponding to UL transmissions on a serving cell when the cell is configured or indicated for SBFD operation in absence of a carrier aggregation or dual-connectivity configuration provided to the UE and the UE indicates or reports a second value for a supported UL duty cycle on the serving cell when the cell with SBFD operation is configured or indicated to the UE as a serving cell in a carrier aggregation or dual-connectivity configuration.

In one example, a separate value for a supported UL duty cycle associated with a power class for SBFD and non-SBFD slots/symbols, respectively, may correspond to a default value, e.g., n50 or 50%. The absence of a field indicative of a supported UL duty cycle other than the default UL duty cycle, e.g., 50%, in the corresponding UE capability signaling may imply that the UE supports the default UL duty cycle for the indicated or reported power class in an SBFD slot/symbol on the carrier or on the band. Alternatively, a supported UL duty cycle on the carrier or in the band for SBFD slots/symbols and non-SBFD slots/symbols, respectively, may be separately indicated or signaled as a value or a setting in the UE capability signaling.

A default UL duty cycle corresponding to a UE power class may be a same or different for SBFD slots/symbols and for non-SBFD slots/symbols, respectively. For example, a default UL duty cycle for SBFD slots/symbols or a set of slots/symbols comprising an SBFD slot/symbols and/or non-SBFD slot/symbols may be provided, indicated or tabulated by system operating specifications. Furthermore, a default UL duty cycle associated with an SBFD slot/symbol may be further associated with additional conditions or restrictions as elaborated in other embodiments.

In one example, a default UL duty cycle associated with a power class for non-SBFD slots/symbols may correspond to 50% but a separate default UL duty cycle for a set of slots/symbols comprising an SBFD symbol may correspond to 70%.

Similar instances based on previous examples can be applied to other cases such as a first UL duty cycle associated with UL transmissions in a first set of slots/symbols and a second UL duty cycle associated with a second set of slots/symbols on a carrier or in a band, respectively, wherein the first or the second set can comprise a combination of SBFD and non-SBFD symbols, or to other cases such as an UL duty cycle associated with a UE Power Classes other than the example PC2 such as PC1.5 or PC1, or to other cases such as an UL duty cycle for UE operation in FR1, FR2 or FR3 to determine a UE maximum output power or an UL transmission power.

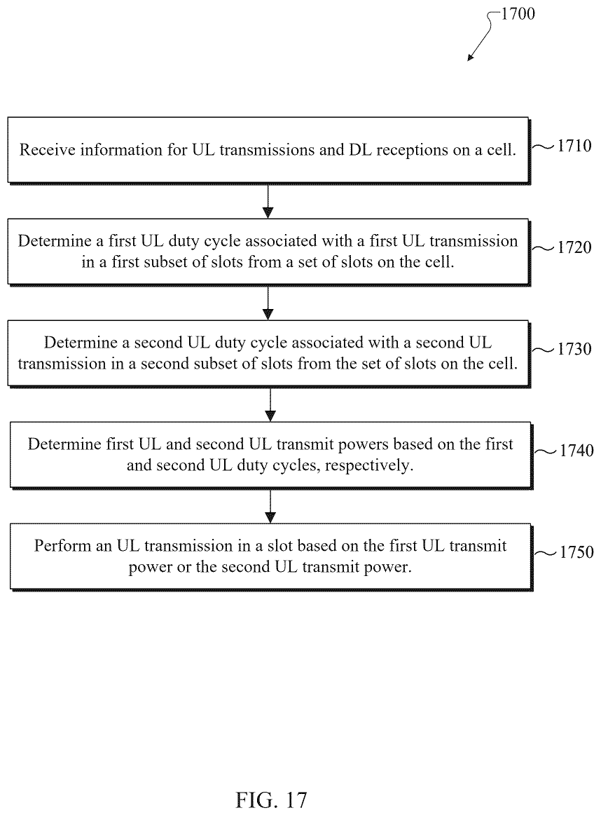

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving information for UL transmissions and DL receptions on a cell (1710). The UE then determines a first UL duty cycle associated with a first UL transmission in a first subset of slots from a set of slots on the cell (1720). For example, in 1720 the determination is based on the information received in 1710. The UE then determines a second UL duty cycle associated with a second UL transmission in a second subset of slots from the set of slots on the cell (1730). For example, in 1730 the determination is based on the information received in 1710. In various embodiments, the first and second UL duty cycles are associated with first and second maximum UL duty cycles, respectively. In various embodiments, the information includes values for first and second maximum UL duty cycles for the UL transmission. In various embodiments, the UE transmits, via UCI, a MAC-CE, or a RRC message, values for the first and second UL duty cycles.

The UE then determines first UL and second UL transmit powers based on the first and second UL duty cycles, respectively (1740). In various embodiments, the UE determines the first and second UL transmit powers that meet a MPE limit based on the first and second UL duty cycles, respectively. The UE then performs an UL transmission in a slot based on the first UL transmit power or the second UL transmit power (1750). In various embodiments, the UL transmission is based on the first UL transmit power when the slot is from the first subset of slots and the UL transmission is based on the second UL transmit power when the slot is from the second subset of slots. In various embodiments, the slot is from the second subset of slots and is indicated for simultaneous transmission and reception during a same time-domain resource on the cell.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
receiving information for uplink (UL) transmissions and downlink (DL) receptions on a cell;
determining, based on the information, a first UL duty cycle associated with a first UL transmission in a first subset of slots from a set of slots on the cell;
determining, based on the information, a second UL duty cycle associated with a second UL transmission in a second subset of slots from the set of slots on the cell;
determining a first UL transmit power and a second UL transmit power based on the first and second UL duty cycles, respectively; and
performing an UL transmission in a slot based on the first UL transmit power or the second UL transmit power.

2. The method of claim 1, wherein:
the UL transmission is based on the first UL transmit power when the slot is from the first subset of slots, and
the UL transmission is based on the second UL transmit power when the slot is from the second subset of slots.

3. The method of claim 1, wherein the slot is from the second subset of slots and is indicated for simultaneous transmission and reception during a same time-domain resource on the cell.

4. The method of claim 1, wherein the first and second UL duty cycles are associated with first and second maximum UL duty cycles, respectively.

5. The method of claim 1, wherein determining the first and second UL transmit powers further comprises determining the first and second UL transmit powers that meet a maximum permissible exposure (MPE) limit based on the first and second UL duty cycles, respectively.

6. The method of claim 1, wherein the information includes values for first and second maximum UL duty cycles for the UL transmission.

7. The method of claim 1, further comprising transmitting, via uplink control information (UCI), a medium-access-control (MAC) control element (CE), or a radio resource control (RRC) message, values for the first and second UL duty cycles.

8. A user equipment (UE), comprising:
a transceiver configured to receive information for uplink (UL) transmissions and downlink (DL) receptions on a cell; and
a processor operably coupled with the transceiver, the processor configured to:
determine, based on the information, a first UL duty cycle associated with a first UL transmission in a first subset of slots from a set of slots on the cell;
determine, based on the information, a second UL duty cycle associated with a second UL transmission in a second subset of slots from the set of slots on the cell; and
determine a first UL transmit power and a second UL transmit power based on the first and second UL duty cycles, respectively,
wherein the transceiver is further configured to perform an UL transmission in a slot based on the first UL transmit power or the second UL transmit power.

9. The UE of claim 8, wherein:
the UL transmission is based on the first UL transmit power when the slot is from the first subset of slots, and
the UL transmission is based on the second UL transmit power when the slot is from the second subset of slots.

10. The UE of claim 8, wherein the slot is from the second subset of slots and is indicated for simultaneous transmission and reception during a same time-domain resource on the cell.

11. The UE of claim 8, wherein the first and second UL duty cycles are associated with first and second maximum UL duty cycles, respectively.

12. The UE of claim 8, wherein the processor is further configured to determine the first and second UL transmit powers that meet a maximum permissible exposure (MPE) limit based on the first and second UL duty cycles, respectively.

13. The UE of claim 8, wherein the information includes values for first and second maximum UL duty cycles for the UL transmission.

14. The UE of claim 8, wherein the transceiver is further configured to transmit, via uplink control information (UCI), a medium-access-control (MAC) control element (CE), or a radio resource control (RRC) message, values for the first and second UL duty cycles.

15. A base station (BS), comprising:
a transceiver configured to transmit information for uplink (UL) transmissions and downlink (DL) receptions on a cell; and
a processor operably coupled with the transceiver, the processor configured to:
determine, based on the information, a first UL duty cycle associated with a first UL transmission in a first subset of slots from a set of slots on the cell;
determine, based on the information, a second UL duty cycle associated with a second UL transmission in a second subset of slots from the set of slots on the cell; and
determine a first UL transmit power and a second UL transmit power based on the first and second UL duty cycles, respectively,
wherein the transceiver is further configured to receive an UL transmission in a slot, wherein the UL transmission is based on the first UL transmit power or the second UL transmit power.

16. The BS of claim 15, wherein:
the UL transmission is based on the first UL transmit power when the slot is from the first subset of slots, and
the UL transmission is based on the second UL transmit power when the slot is from the second subset of slots.

17. The BS of claim 15, wherein the slot is from the second subset of slots and is indicated for simultaneous transmission and reception during a same time-domain resource on the cell.

18. The BS of claim 15, wherein the first and second UL duty cycles are associated with first and second maximum UL duty cycles, respectively.

19. The BS of claim 15, wherein the first and second UL transmit powers meet a maximum permissible exposure (MPE) limit based on the first and second UL duty cycles, respectively.

20. The BS of claim 15, wherein the information includes values for first and second maximum UL duty cycles for the UL transmission.
